(19) United States
(12) Patent Application Publication
(10) Pub. No.: US 2015/0134597 A1
(43) Pub. Date: May 14, 2015

(54) DOCUMENT ANALYSIS AND PROCESSING SYSTEMS AND METHODS

(71) Applicant: UBC Late Stage, Inc., Blue Bell, PA (US)

(72) Inventors: Othniel Badea, Pennsburg, PA (US); Bernardo Duran, Acton, MA (US); Alejandro Gutierrez Seguro, Itagui (CO)

(21) Appl. No.: 14/535,663

(22) Filed: Nov. 7, 2014

Related U.S. Application Data
(60) Provisional application No. 61/901,798, filed on Nov. 8, 2013.

(51) Int. Cl. G06F 17/30

(52) U.S. Cl. CPC G06F 17/30867; G06F 17/30592
USPC 707/603

(57) ABSTRACT

Document analysis and processing subsystem are disclosed. In one embodiment, review criteria, data entry definition of data entry forms, and a methodology definition of a data entry methodology are stored. Limited information access is provided to literature review items identified in a literature review search. Initial review data is received through a data entry form. A determination is made that a literature review item has met an acceptance criterion. The literature review item is moved through at least one additional level of review based on a determination that the literature review item has met the acceptance criterion. Greater information access is provided to the literature review item. Additional methods and systems are disclosed.

### CROSS-REFERENCE TO A RELATED APPLICATION

This application claims the benefit of U.S. provisional patent application 61/901,798 filed on 8 Nov. 2013, entitled “Systems and Methods for Literature Review,” the entire disclosure of which is incorporated herein by reference.

### FIELD

The field relates systems and methods for document analysis and processing, and more particularly to systems and methods for facilitating a literature review.

### BACKGROUND

In at least certain countries, pharmaceutical companies have the regulatory obligation to monitor literature for articles presenting information on the safety of their drugs. The review of the literature can lead to the detection of individual pharmacovigilance cases, or the identification of safety signals.

### BRIEF DESCRIPTION OF THE DRAWINGS

FIG. 1 is a block diagram of an example system according to an example embodiment;

FIG. 2 is a block diagram of an example operator device that may be deployed within the system of FIG. 1, according to an example embodiment;

FIG. 3 is a block diagram of an example resource device that may be deployed within the system of FIG. 1, according to an example embodiment;

FIG. 4 is a block diagram of an example document analysis and processing subsystem that may be deployed within the operator device of FIG. 2 or the resource device of FIG. 3, according to an example embodiment;

FIGS. 5 and 6 are example process flows illustrating methods for document analysis and processing, according to example embodiments;

FIGS. 7-33 are example displays according to example embodiments;

FIG. 34 is an example process flow illustrating a method for conducting a literature review process, according to an example embodiment; and

FIG. 35 is a block diagram of a machine in the example form of a computer system within which a set of instructions for causing the machine to perform any one or more of the methodologies discussed herein may be executed or stored.

### DETAILED DESCRIPTION

Example document analysis and processing systems and methods are described. In the following description, for the purpose of explanation, numerous specific details are set forth in order to provide a thorough understanding of example embodiments. It will be evident, however, to one of ordinary skill in the art that embodiments of the invention may be practiced without these specific details.

The document analysis and processing systems and methods may facilitate performance of a literature review. The literature review may utilize the systems and methods to conduct searches into major databases (e.g., Embase from Elsevier B.V., PubMed from the U.S. National Library of Medicine, or the like) on a weekly or other basis, review the abstracts for information of relevance, and when relevance is found, order or otherwise obtain the full text article for complete review. The methods and systems may screen provided literature articles for automated tracking of the review of the abstracts, and of the decision for full text ordering and review.

The methods and systems enable users to create levels which can be applied to each literature item depending on the nature of the protocol of the literature review project. As such, a user may define a level as a stage of acceptance of the literature review item, a category to which the literature review item belongs or the type of abstracted data the literature review item will be subject of, among many other possibilities. The methods and systems further enable configure of data entry forms, the reject reasons and other settings applying to each of those levels.

The methods and system enable performance of a double data entry protocol including functionality that greatly facilitate the discrepancy resolution of each literature review items status, reject reasons, and the data collected.

The methods and system enable an ability to segregate the work within a literature review project among several users and follow up on the progress of these users, provide features that facilitates the screening process, and enables configurable keyword highlighting of words or regular expressions within the abstract of the literature review items.

The methods and systems further enable an ability to synchronize the display of the abstract or full source document of literature items side by side with a screening form or in a different window/display, configurable rules to automatically accept or reject literature review items based on the individual data collected or combination of it used in logical expressions, control of concurrent access of users to the same literature review item, and controls the procurement process of the source documents from an internal or external repository. When an internal repository is used, the methods and systems may index the repository and automatically match or partially match the source documents to the literature review items based on their key fields.

The methods and systems further enable batch import of source documents with automatic and semi-automatic match of source documents to the corresponding literature review items, ability to query a database using custom logical expressions build on data entry fields collected, and creation of custom edit checks that evaluates one or multiple data entry forms fields. Those edit checks may be run in batch and the methods and system may allow managing the resolution process of the instance issues found.

The methods and systems may increase the efficiency of performing literature reviews and provide tracking with an automated tool with audit trail, as manual tracking may become cumbersome when a project reaches a certain volume. The methods and systems may provide for extracting reports and key performance indicators (KPIs) on timelines and metrics. The methods and systems may provide for audits by clients and automated validated solutions in line with authority's expectations.

In some embodiments, the review of numerous articles manually would be time consuming and may not be ideal to meet the demands of pharmaceutical use or medical care management. A person or entity may not have adequate resources at any given time to complete the study, which a drug development company may have. Hence, a knowledge database and repeatable, uniform processes as provided in the methods and systems may increase the time and cost effectiveness of performing a literature review.

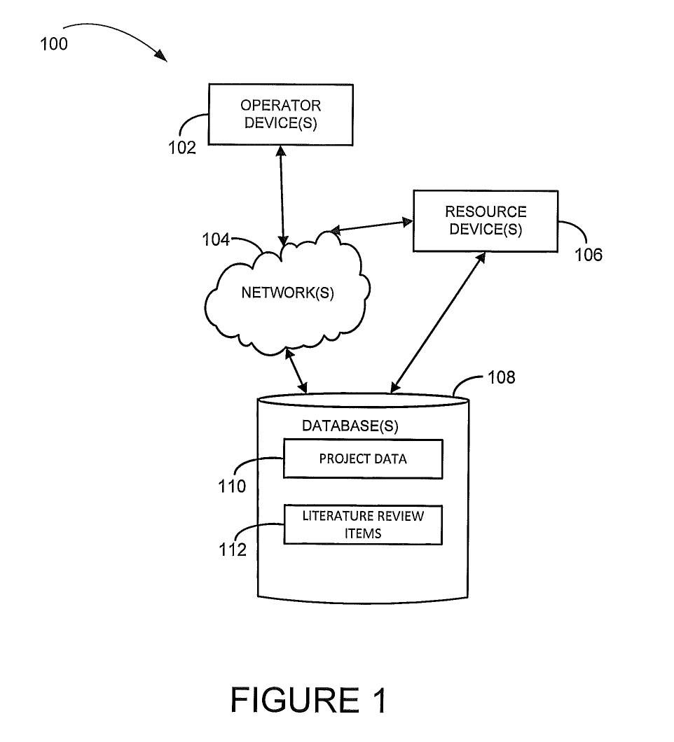

FIG. 1 is a block diagram of an example system 100, according to an example embodiment. The system 100 is an example embodiment in which document analysis and processing systems and methods may be performed (e.g., to enable a literature review). The system 100 includes an operator device 102 in communication with a resource device 106 over a network 104.

The operator device 102 is used by a device operator. The device operator may be an employee or other worker of an organization conducting a literature review project, a contract employee conducting at least a portion of a literature review project on behalf of an organization, or either the organization itself or for the organization on behalf of a third party. In some embodiments, the device operator may utilize the operator device 102 to communicate with the resource device 106.

Examples of the devices 102, 106, include a personal computer, a notebook computer, a tablet computer, a netbook computer, a set-top box (STB), a receiver card, a mobile telephone, a personal digital assistant (PDA), a display device, a portable gaming unit, and a computing system; however other devices may also be used. For example, the devices 102, 106, may include a mobile electronic device, such an IPHONE or IPAD device by Apple, Inc., mobile electronic devices powered by ANDROID by Google, Inc., and a BLACKBERRY device by Research In Motion Limited. The devices 102, 106, may also include other computing devices, such as desktop computing devices, notebook computing devices, netbook computing devices, gaming devices, and the like. Other types of electronic devices may also be used. In some embodiments, the devices 102, 106 when executing the method steps described herein, are a specific machine dedicated to the present disclosure.

The network 104 by which one or more than one of the devices 102, 106, communicate may include, by way of example, Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. The network 104 may also include optical communications. Other conventional and/or later developed wired and wireless networks may also be used. In some embodiments, the network 104 may include proprietary network communication technologies such as secure socket layers (SSL) technology, technology found in a prescribing network (e.g., the electronic prescribing network operated by Surescripts of Arlington, Va.), and the like.

The resource device 106 is a device operated by an entity at least partially responsible for the management of a literature review project. For example, the entity at least partially responsible for the management of the literature review project may manage the literature review project for the entity's own use or benefit. In other embodiments, the entity that is at least partially responsible for the management of the literature review project may manage the literature review project for an operator of the resource device 106 or benefit of a third party. In an example embodiment, a literature review project may include a review of literature relative to adverse events associated with a pharmaceutical drug or a medical treatment. In such an example, the entity at least partially responsible for the management of the literature review project, or the third party on whose behalf the literature review project is managed, may include a pharmaceutical development company, a medical device company, a medical research organization, or the like. In some embodiments, a literature review may be conducted relative to subject matter unrelated to pharmaceuticals, medical device, or medical treatments. For example, a literature review may be conducted relative to various scientific endeavors, such as climate change, topics of physics, or otherwise.

In some embodiments, the entity at least partially responsible for management of the literature review project may also be involved or have experience in one, or more than one, of the following areas: clinical development; late stage development and commercialization; value demonstration; safety, pharmacoepidemiology, risk management; strategic consulting; patient support services (e.g., such as reimbursement, nursing, and/or adherence); patient and physician recruitment and retention; or data analytics; and reimbursement, patient assistance, and alternate funding programs for drug development or distribution.

In some embodiments, the entity at least partially responsible for management of the literature review project may customize global development and commercial support services to optimize product approval and characterize therapeutic value by providing clinical development, late stage development, data management and biometrics, database analytical tools, patient and physician recruitment and retention, site feasibility and selection.

In some embodiments, the entity at least partially responsible for management of the literature review project may develop, deliver, and report evidence to reinforce safe and appropriate product use by providing risk management, consulting and protocol development, risk evaluation and mitigation strategies (REMS) and REMS with elements to assure safe use (ETASU), REMS implementation system, knowledge surveys (REMS/RMP), risk management technology services, pharmacovigilance, case processing and reporting, safety writing and consulting, periodic reporting and regulatory compliance, safety database.

In some embodiments, the entity that is at least partially responsible for management of the literature review project may seek to maximize reach and optimize commercial entry through custom channel management by providing specialty pharmacy, specialty distribution, and third party logistics.

In some embodiments, the entity that is at least partially responsible for management of the literature review project may navigate barriers that impede timely access to therapy by providing reimbursement services, hub solutions, and patient assistance programs.

In some embodiments, the entity at least partially responsible for management of the literature review project may optimize therapeutic experience and outcomes through customized, clinically-focused programs by providing customized adherence programs, site of care, clinical support center, and clinical trial support.

The resource device 106 and/or the operator device 102 may be in communication directly (e.g., through local storage or peer-to-peer connection(s)) and/or through the network 104 (e.g., in a cloud configuration or software-as-a-service) with a device that stores a database 108. The database 108 may be deployed on the resource device 106, on the operator device 102, on a separate device, or may otherwise be deployed in storage devices. The database 108 may store project data 110 and/or literature review items 112.

The project data 110 may include information regarding various literature review items 112 that may be examined relative to one, or to more than one, literature review project. This information, stored as the project data 110, may reflect the literature review that was performed relative to one or more than one of the literature review items 112. The project data 110 may include relationships between the information and individual literature review items 112 reflecting a result of the literature review that was performed and the associated literature review items 112 on which the review was made. The project data 110 may include relationships between the information and one, or more than one, literature review project. Examples of the project data 110 may include an identification of literature review items 112 reviewed relative to a literature review project, information abstracted from one, or more than one, literature review items 112, including bibliographical information, details concerning the nature of the topic of the literature review item, as well as other information abstracted from the literature review item 112. The project data 110 may also include records of actions taken as consequence of review literature review items 112, such as reporting adverse events or submitting literature review items 112 to specialized groups (internal or external) for additional processing. Submitting literature review items 112 may include electronically transmitting the literature review items 112 to additional devices or notifying a specialized group of literature needing review or available at a device storing the database 108.

In general, a literature review project may include the review of various sources of information, such as articles from various publications (e.g., magazines, professional journals, or the like), research papers, and the like. Such sources of information can be machine-readable, storable and producible (e.g., digital) information services and stored as literature review items 112 in the database 108. The various sources of information may be reviewed to identify and aggregate various findings reported in the articles, or other types of information that may be included within, derived from, or otherwise obtained from the review of the articles. As such, a literature review may provide information on critical points of current knowledge, substantive findings, and/or theoretical and methodological contributions to a particular topic that have been provided by people and/or organizations working or conducting studies relative to the topic.

The literature review items 112 may include electronic copies of any collection of articles in the form of writings or other materials relating to one, or more than one, topic. Each individual literature review item 112 may have articles such as a journal article, a research paper, a topical publication, or other materials. In some embodiments, the literature review item 112 is and/or includes an abstract or summary of the article. At least a portion of the literature review items 112 may be reviewed relative to one, or more than one, literature review projects. In some embodiments, all of the literature review items 112 related to a particular literature review project will be reviewed at least at some level of scrutiny or consideration for that literature review project.

In general, each publication may be considered a literature review item 112. In some embodiments, the literature review item 112 may consist of an article abstract or other summary or introductory information of a publication. In some embodiments, the literature review item 112 may include the article text of a publication. In some embodiments, limited information (e.g., the article abstract or other summary or introductory information of a publication) is initially provided about a literature review item 112 until desirability of the literature review item 112 is expressed or determined. In such embodiments, greater information (e.g., the article text of a publication) is obtained when not already available and then provided about the literature review item 112.

While the system 100 in FIG. 1 is shown to include single devices 102, 106 multiple devices may be used. The devices 102, 106 may be the same type of device or may be different device types. When multiple devices are present, the multiple devices may be of the same device type or may be a different device types. Functionality of some or all of the devices 102, 106 may be combined into a lesser number of devices, or may be spread among a greater number of devices. For example, the functionality of devices 102, 106 may be combined into a single device.

Moreover, system 100 shows a single network 104, however, multiple networks may be used. The multiple networks may communicate in series with each other to link the devices 102, 106, 108 or in parallel to link the devices 102, 106. The devices 102, 106 may be in a client-server relationship with one another, a peer-to-peer relationship with one another, in a different type of relationship with one another, or in a combination of different types of relationships with one another. The devices 102, 106, either as stand-alone or multiple connected devices, operate as specific machines when executing present method steps for as described herein.

The person(s) and/or organization(s) operating the devices 102, 106 may be the same person or organization, or may be operated by different persons or organizations.

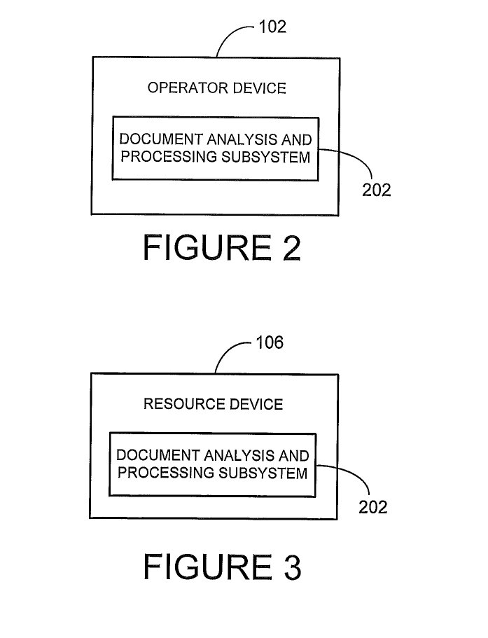

FIG. 2 illustrates the operator device 102, according to an example embodiment. The operator device 102 may include a document analysis and processing subsystem 202. The document analysis and processing subsystem 202 may enable at least some operations relative to conducting a literature review project, including, but not limited to, defining the literature review project, managing the literature review project, and conducting the literature review project. The operator device 102 may be deployed in the system 100, or may otherwise be used.

The document analysis and processing subsystem 202 may include software, hardware, firmware, or combinations thereof. In some embodiments, the document analysis and processing subsystem 202 may include dedicated circuitry, e.g., be loading instructions in to circuitry or programming the circuitry.

By way of example, the document analysis and processing subsystem 202 may be utilized in connection with conducting a pharmaceutical literature review. In general, a pharmaceutical literature review includes a specialized technical and scientific review of pharmaceutical literature in a study. In such an embodiment, a collection of literature review items 112 relating to a review topic such as common pharmaceutical drug, treatment protocol, or the like may be analyzed utilizing the document analysis and processing subsystem 202 to conduct a study that identifies adverse events, safety information, treatment benefits, drug performance, or some other characteristic, all related to a drug, treatment protocol, or the like.

In an example embodiment, the document analysis and processing subsystem 202 may generally conduct analysis and/or facilitate analysis of the various literature review items 112 relating to the review topic. For example, the document analysis and processing subsystem 202 may allow or enable information regarding the review topic to be collected, analyzed, and associated with individual literature review items 112. For example, the document analysis and processing subsystem 202 may be used to collect specific pieces of information from the individual literature review items 112 for filtering, classifying, or categorizing the various literature review items included in the collection of literature review items 112. The relevance of the individual literature review items relative to a given literature review project or study may then be a determined (e.g., by a device operator and/or the document analysis and processing subsystem 202). Further, the collection of specific pieces of information may, in some situations, assist in later analysis of the literature review items 112 such as to determine the actual meaning or content of the literature review items 112. As such, the document analysis and processing subsystem 202 may conduct and/or facilitate analysis of the various literature review items 112 to determine which literature review items may be relevant to a particular literature review or study. The literature review items 112 that are determined to be relevant to the literature review or study may be, for example, further analyzed for their specific findings regarding the review topic, or a particular facet of the review topic.

FIG. 3 illustrates the resource device 106, according to an example embodiment. The resource device 106 may include the document analysis and processing subsystem 202. The resource device 106 may be deployed in the system 100, or may otherwise be used.

In an embodiment, all of the functionality of the document analysis and processing subsystem 202 may be performed by the operator device 102, or all of the functionality of the document analysis and processing subsystem may be performed by the resource device 106. In some embodiments, at least a portion of the functionality of the document analysis and processing subsystem 202 may be performed by the operator device 102, and at least a portion of the functionality of the document analysis and processing subsystem 202 may be performed by the resource device 106. In some embodiments, at least a portion of the functionality of the document analysis and processing subsystem 202 may be performed by another device.

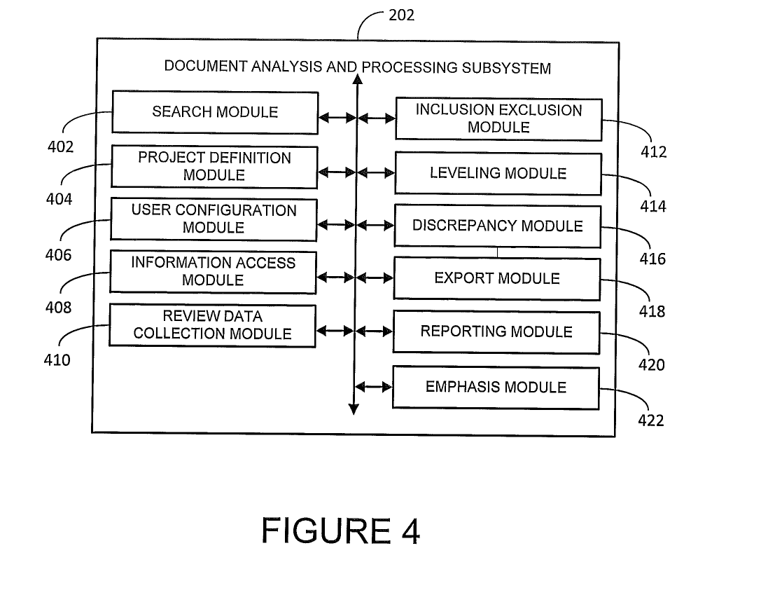

FIG. 4 illustrates an example document analysis and processing subsystem 202 that may be deployed in the operator device 102, the resource device 106, or otherwise deployed in another system. One or more modules are communicatively coupled and included in the document analysis and processing subsystem 202 to enable claims data processing. The modules of the document analysis and processing subsystem 202 that may be included are a search module 402, a project definition module 404, a user configuration module 406, an information access module 408, a review data collection module 410, an inclusion exclusion module 412, a leveling module 414, a discrepancy module 416, an export module 418, a reporting module 420, and an emphasis module 422. Other modules may also be included.

In some embodiments, the modules of the document analysis and processing subsystem 202 may be distributed so that some of the modules are deployed in one of the devices 102, 106, and other modules are deployed one or more of the devices 102, 106. In one embodiment, the modules are deployed in memory and executed by a processor coupled to the memory. The functionality contained within the modules 402-422 may be combined into a lesser number of modules, further divided among a greater number of modules, or redistributed among existing modules. Other configurations including the functionality of the modules 402-422 may be used.

The search module 402 may be used to conduct a search of relevant literature to provide a collection of literature review items 112 relating to a review topic of a study for which a literature review is desired. The topic may depend on the investigational goal of a project. In an embodiment, the topic may, for example, relate to the efficacy, performance, or adverse events associated with a pharmaceutical drug, a medical device, a treatment protocol, or the like. In some embodiments, the topic may relate to other endeavors, such as various scientific topics.

In general, the literature review items 112 may include variously include journal articles, research papers, or any other relevant publication or source. The search may be conducted across a variety of sources, including professional, technical, medical, and scientific journals, publication, article collections, published papers, as well as various other sources. The sources searched may be defined by the scientific staffing leading a project or otherwise. The search may be conducted using any variety of manual and electronic search tools suitable for uncovering publications, literature or items relevant to the topic such as the EMBASE database offered by Elsevier B.V. In some embodiments, the collection of literature review items 112 may be stored in a database, such as the database 108. In some embodiments, the results of the literature review search itself may be stored.

In some embodiments, the search may uncover a variety of individual literature review items, wherein each individual literature review item may include a separate article, paper, or publication. The uncovered literature review items may include electronic versions of the literature review items and/or print versions of the literature review items, which may be converted to an electronic format (e.g., as by scanning). In some embodiments, the search module 402 may enable review of hard copies of literature review items as well as soft copies in electronic form. In an embodiment, the soft copies of the individual literature review items may be stored as the literature review items 112 within the database 108. The literature review items 112 may be accessed by the operator device 102, the resource device 106, and/or may be otherwise accessed.

The literature review items may initially be stored in the form of being more limited in nature (e.g., including abstract text without article text), in a form more expansive in nature (e.g., including the article text), or otherwise by the search module 402. The collection of literature review items 1112 may, for example, include tens, hundreds, thousands, or even more individual literature review items 112.

In some embodiments, the search may be conducted by a device operator of the operator device 102 or of the resource device 106 through use of the search module 402, or may be otherwise conducted. In some embodiments, the search relative to the given topic may be conducted by a third party with results being sent to the search module 402, or stored in the database 108 (e.g., as a portion of the project data 110 and/or the literature review items 112).

A literature review project may be defined through the project definition module 404. In some embodiments, the literature review project may be defined by a device operator having sufficient permissions or privileges. The defining of the literature review project generally includes the project definition module 404 receiving and/or storing certain aspects of the literature review project.

An aspect of defining the literature review project may include the project definition module 404 receiving and/or storing review criteria for a literature review project. The project definition module 404 may thereby define criteria by which individual literature review items 112 that will be reviewed during the course of the literature review project may be excluded and/or included with the study. The study may include an analysis or aggregation of information regarding the topic of the literature review project. For example, depending upon the scope of study, the findings, methodologies, or conclusions of one or more than one individual literature review item 112 may not be considered to be useful, may detract from the objective of the study, or may otherwise not be relevant. For example, the study for which the literature review project is being conducted is interested in the effects of a pharmaceutical drug on males between the ages of 20 and 40. For such a study, the findings or conclusions of a literature review item including a patient group that is undivided by gender and has an age range of between 30 and 60 may not be pertinent. As such, the literature review item 112 may be excluded from the study. Depending upon the nature of the study, various exclusion criteria may be established. Examples of exclusion criteria may include research type (e.g., living versus in vitro), patient demographics (e.g., age, gender, geographical location), the number of patients included in the research, literature review item type or attributes. Various additional and/or alternative exclusion criteria may be established. Similarly, inclusion criteria, by which a literature review item 112 will be included in the study, notwithstanding other criteria, may also be defined.

In addition to defining exclusion criteria, defining the literature review project through the project definition module 404 may include defining the manner by which literature review items 112 may be excluded from the study. For example, only a single basis for excluding a literature review item may be allowed, or multiple bases for excluding a single literature review item may be permitted. The project definition established by the project definition module 404 may require that the reason for excluding a literature review item be specified. The project definition module 404 may provide a definition that allows for no reason for excluding a literature review item to be specified. Manual exclusion criteria may be defined on or by the project definition module 404, by which a user reviewing a literature review item 112 may manually exclude the literature review item from the study. Automatic exclusion criteria may be defined on or by the project definition module 404, by which a literature review item 112 may be automatically excluded from the study on the basis of information collected relative to the literature review item 112. Other exclusion and inclusion criteria and methodologies may also be defined on or by the project definition module 404.

An aspect of defining the literature review project may include the project definition module 404 receiving and/or storing a data entry definition of a number of data entry forms for the literature review project. The data entry forms may be configured in accordance with the data entry definition to receive literature review item analysis information through a multi-level review. In general, a data entry form includes identification of pieces of information to be collected or abstracted from a literature review item.

In general, the forms for data entry as defined through the project definition module 404 may include questionnaires to be utilized by a data entry user (e.g., a user reviewing a literature review item 112 and entering data regarding the literature review item 112 into the data entry form) for collecting information regarding the literature review items. The data collected through the data entry forms depend on the research goal or topic of the specific project.

The data entry forms may include an identification of pieces of information to be collected or abstracted from the literature review items 112. The data entry forms may also include a data entry mechanism that allows the data entry user to record the information associated with the literature review item 112. Examples of data entry mechanisms may include text entry boxed, by which the data entry user may type the relevant information into the form, pull down menus by which the data entry user may select an appropriate response to the requested information, as well as various other data entry mechanism. Examples of information that may be collected include, bibliographical information (e.g., literature review item author, publication date, journal, etc.), research parameters of the literature review item 112 (e.g., living or in vitro, patient demographics, etc.), as well as any other information that may be useful or of interest to the study (e.g., as decided by the scientific staff conducting the study. The use of forms provides repeatable and consistent data collection and storage across an entire study and between different studies. The use of forms may allow the collected and stored data to be used again, e.g. in other studies or in view of changes to study parameters.

An aspect of defining the literature review project may include the project definition module 404 receiving and/or storing a methodology definition of a data entry methodology. The methodology definition may define a number of per item reviewers for the literature review project.

The data entry methodology may include, for example, a single data entry methodology. In a single data entry methodology, each literature review item 112 may be reviewed by a single reviewer (e.g., data entry user via the operator device 102), and the data collected relative to each literature review item 112 may only be recorded by the single data entry user. Defining the data entry methodology may also include defining a percentage of the data entries by the single user that may be reviewed, or double checked, by another user. Defining the data entry methodology may also include defining a double data entry methodology. In a double data entry methodology, each literature review item 112 may be reviewed by two different data entry users via the operator devices 102 and the data may be entered into the various data entry forms by each of the two data entry users. As such, double data entry may provide complete redundancy, e.g., which may provide a higher likelihood that the collected data will be correct. Defining the data entry methodology may also include defining the review and discrepancy resolution methodologies. The review methodology may define the extent to which data collected via single data entry may be reviewed by another user, and the discrepancy resolution methodology may define the manner in which discrepancies in data collected via double data entry may be resolved.

The one or more than one users may be associated with the literature review project in various different capacities, such as a project manager, a data entry user, and/or another capacity through the user configuration module 406. The one or more than one users associated with the literature review project may be assigned different privileges or permissions by or through the user configuration module 406 depending upon the capacity and/or role of the user with respect to the literature review project. For example, the user configuration module 406 may associate a particular person as a data entry user for and then provide that user with a particular role in the literature review project.

The information access module 408 may access the literature review items 112 and providing the literature review items 112 (or a subset of the literature review items 112) to one or more than one devices 102 for use by associated data entry users. The information access module 408 may thus provide information access to literature review items 112. For example, the information access module 408 may provide limited information access to literature review items 112 identified in a literature review search on the topic and greater information access to a subset of the literature review items identified in the literature review search. In some embodiments, limited information access may be provided to a first portion of literature review items identified in a literature review search to a first person and to a second portion of the literature review items identified in the literature review search to a second person. In some embodiments, the limited information access to the literature review items is abstract text of the review items. The information access module 408 may also provide the data entry forms to one, or more than one, data entry users to collect information regarding the presented literature review items 112.

The review data collection module 410 receives data entries consisting of data regarding, or based upon, the literature review items 112 consistent with the defined literature review process. Further, receiving data entries may include receiving data entry forms including entered data regarding the literature review items 112 from the one, or more than one, data entry users. The entered data regarding the literature review items 112 may be stored as the project data 110 in the database 108.

In some embodiments, the review data collection module 410 receives initial review data through a first data entry form in accordance with the data entry methodology and providing of the limited information access to the literature review items. In some embodiments, the initial review data is received through the data entry form in accordance with the data entry methodology and providing of the limited information access to the first portion and the second portion of the literature review items. In some embodiments, the initial review data includes an acceptance of the literature review item.

The inclusion exclusion module 412 manually and/or automatically includes or excludes literature review items from a study. The literature review item 112 may be excluded from the study by the inclusion exclusion module 412 because one or more the one aspects of the research, conclusions, or methodology associated with the literature review item 112 make it inapplicable or not useful to the study for which the literature review is conducted. In some embodiments, the literature review item 112 may be automatically excluded from the study by the inclusion exclusion module 412 if a data item is entered in a data form that has been defined as automatic exclusion criteria. In some such embodiments, upon entry of a data item matching defined automatic exclusion criteria the literature review item 112 may be immediately excluded from the study by the inclusion exclusion module 412. In some embodiments, the literature review item 112 may only be excluded by the inclusion exclusion module 412 at the completion of a specified level of review. Automatic exclusion may be performed by the inclusion exclusion module 412 by applying stored rules (e.g., in the form of project data 110) to the data available and related to a study and to exclude a literature review item 112 from the current study.

In addition to automatically excluding a literature review item as a result of receiving an input of a data item that matches an automatic exclusion criteria, one or more than one literature review items 112 may be manually excluded by the inclusion exclusion module 412 based upon, at least in part, a selection or indication by a data entry user that the literature review item 112 includes a basis for exclusion from the study. As described above, exclusion criteria, which may form a basis for exclusion from the study, may be defined as part of defining the literature review project. During the course of reviewing a literature review item, a data entry user may make a selection or indication that the literature review item 112 should be excluded from the study. In some embodiments, the data entry may provide a selection or indication of more than one reason for excluding the literature review item 112 from the study. In some embodiments, the data entry user may simply provide a selection or indication that the literature review item 112 should be excluded without providing a reason for the exclusion. In some embodiments, the data entry user may provide a reason for excluding the literature review item 112 from the study. Providing a reason for excluding the literature review item 112 from the study may include selecting a reason from a list of possible reasons. Providing a reason for excluding the literature review item 112 from the study may include entering one or more than one data items that match exclusion criteria. For example, for a study concerned with the effects of a pharmaceutical product on patients between the ages of 20 and 40, the data entry user may enter a patient age range date item indicating a patient age range of 30 to 60 in the literature review item. The inclusion exclusion may receive the input of exclusion or inclusion through the review data collection module 410 or otherwise and set a flag or other indicator relative to a literature review item and a specific study.

The inclusion exclusion module 412 may automatically include a literature review item from the study (e.g., based on receipt of the initial review data associated with a literature review item). The inclusion exclusion module 412 may automatically exclude a literature review item from the study (e.g., based on receipt of the initial review data associated with a literature review item). The inclusion exclusion module 412 may receive an exclusion indication associated with a literature review item to manually exclude it from the study. In some embodiments, the exclusion indication includes an indicated reason for exclusion.

Acceptance, rejection and rejection reasons may be received through the review data collection module 410 that are processed by the inclusion exclusion module 412. In some embodiments, the acceptance, rejection and rejection reasons may be at least a portion of the initial review data and/or the additional review data. In some embodiments, the acceptance, rejection and rejection reasons may separate from the initial review data and/or the additional review data.

The leveling module 414 may move literature review items between different levels of review. During the review of each literature review item, within the same operation the information access module 408 may receiving data entries and indications of acceptance and/or rejection of the literature review items 112. Such entries may also reflect the levels of review through which the literature review items 112 were viewed.

The different levels of review (e.g., which may be defined as part of defining the literature review project) may include categories or classifications applied to the various literature review items 112 depending upon the degree of review that has been conducted relative to each individual literature review item 112. For example, the level of review of a literature review item may be based on which data entry forms have been completed for the literature review item 112. In some embodiments, the literature review items 112 may be automatically moved from one level to another level when one, or more than one, specified data entries forms are received relative to the literature review item 112. In some embodiments, the literature review items 112 may be moved from one level to another level based on an indication or selection received from a data entry user, e.g., which may signify that the specified review has been conducted.

An example of levels of review is as follows. An initial level of review may consist of an abstract screening (e.g., reading the article abstract and basic data in order to accept it or reject it). N other levels of review may follow where the full article text is reviewed and data is collected. Each of those levels may include data entry form(s) for collecting different type of data. The levels may then be organized in a sequential way according to the investigators protocol so the literature review items pass to each level when they satisfy the criteria established for it. In some embodiments, the levels may also represent different paths on the article processing if the investigators design a protocol based on a decision tree or the like.

In some embodiments, the leveling module 414 may determine that a literature review item has met an acceptance criterion (e.g., based on receipt of the initial review data) and moving the literature review item through at least one additional level of review based on a determination that the literature review item has met the acceptance criterion. In some embodiments, the movement is automatic. In some embodiments, a literature review item movement indication is received and moving the literature review item through at least one additional level of review based on a determination that the fourth literature review item has met the acceptance criterion and receipt of the literature review item movement indication.

The information access module 408 provides greater information access to the literature review item 112 based on movement of the literature review item 112. The greater information access may include greater detailed information not included with the limited information access.

The review data collection module 410 receives additional review data through data entry forms in accordance with the data entry methodology and providing of the greater information access to the literature review item 112. In some embodiments, the additional review data includes a rejection of the literature review item 112 and a reject reason for the rejection of the literature review item 112.

The discrepancy module 416 may identify discrepancy between data captured through data entry forms, discrepancies on the acceptance/rejection of literature review items 112 at different review levels, and/or discrepancies on the reject reasons assigned when the literature review item 112 is rejected by multiple reviewers.

In some embodiments, the discrepancy module 416 identifies a discrepancy among the initial review data, the additional review data, or the initial review data and the additional review data received between different reviewers. The discrepancy module 416 may then receive correction data through an additional data entry form in response to identification of the discrepancy. In some embodiments, the discrepancy is the rejection reason for the rejection of the literature review item received from the first person and the second person. In some embodiments, the discrepancy is an acceptance of the literature review item at a first level of review by a first person and a rejection of the literature review item at a second level of review by a second person.

The export module 418 may export literature review report data of the literature review items 112 based on other operations performed by the document analysis and processing subsystem 202. The exportation performed by the export module 418 may include exporting data associated with the various literature review items 112 that was collected via the data entry forms. For example, the data may be exported for use by another program or application, or stored in another storage device. In an example embodiment, the data may be exported in a form that may be utilized by MICROSOFT EXCEL, MICROSOFT WORD, ADOBE PDF, and/or ENDNOTE offered by Thompson Reuters, for the purpose of conducting statistical analysis on the exported data or otherwise. In some embodiments, subset of the data may be exported. For example, the data may be filtered to export only portions of the data for which additional statistical analysis is desired.

The reporting module 420 generating a literature review report of the plurality of literature review items based on the receipt of the initial review data, the automatic inclusion of the first literature review item, the automatic exclusion of the second literature review item, the manual exclusion of the third literature review item, and the receipt of the additional review data.

The emphasis module 422 accesses keyword highlighting configuration data. Providing greater information access to the fourth literature review item based on movement of the fourth literature review item may then include generating a user interface including a portion of text of the fourth literature review item highlighted in accordance with the keyword highlighting configuration data.

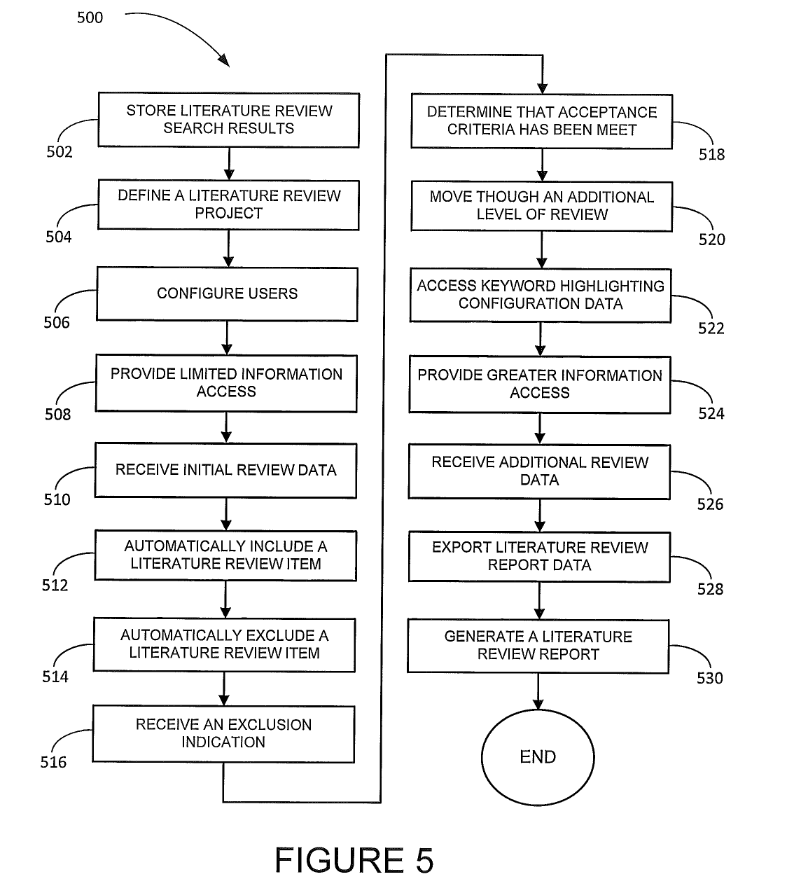

FIG. 5 illustrates an example method 500 for document analysis and processing, according to an example embodiment. The method 500 may be performed by the operator device 102, by the resource device 106, partially by the operator device 102 and partially by the resource device 106, or may be otherwise performed. The method 500 may support a literature reviews performed for a pharmacovigilance activity (e.g., as a regulatory requirement) or as a separate research activity requirement.

At block 502, results from a literature review search about a topic are stored. In some embodiments, a literature review search is conducting across multiple literature sources on the topic to identify the literature review items and the results are then stored as the literature review items 112 in the database 108. In some embodiments, the literature review search is conducted by a first device and the results are then sent transmitted to a second device (e.g., the operator device 102 and/or the resource device 106) for storage in the database 108 and/or directly stored in the database 108 as the literature review items 112.

A literature review project is defined at block 504. In general, defining the literature review project includes receiving and/or storing review criteria for a literature review project, receiving and/or storing a data entry definition of a plurality of data entry forms for the literature review project, and receiving and/or a methodology definition of a data entry methodology. The review criteria generally includes criteria for literature review item inclusion, literature review item exclusion, or literature review item inclusion and exclusion in a study on a topic. The data entry forms are configured in accordance with the data entry definition to receive literature review item analysis information through a multi-level review. The methodology definition generally includes defining a number of per item reviewers for the literature review project.

The users associated with the literature review project may be configured at block 506. For example, a data entry user may be associated with the literature review project. The data entry user may also be associated with a role in the literature review project.

Limited information access to literature review items identified in a literature review search on the topic is provided at block 508.

Initial review data is received through a first data entry form in accordance with the data entry methodology and providing of the limited information access to the literature review items at block 510.

A first literature review item may be automatically included from the study at block 512 based on receipt of the initial review data associated with the first literature review item. A second literature review item may be automatically excluded from the study at block 514 based on receipt of the initial review data associated with the second literature review item.

An exclusion indication associated with a third literature review item may be received at block 516 to manually exclude the third literature review item.

At block 518, a determination that a fourth literature review item of the plurality of literature review items has met an acceptance criterion may be made based on receipt of the initial review data associated with the fourth literature review item. The fourth literature review item may then be moved through at least one additional level of review at block 520 based on a determination that the fourth literature review item has met the acceptance criterion.

In some embodiments, moving the fourth literature review item through at least one additional level of review is performed automatically (e.g., based on the acceptance criterion). In some embodiments, a literature review item movement indication is received and the moving the fourth literature review item through at least one additional level of review is performed on such basis.

In some embodiments, keyword highlighting configuration data is accessed at block 522.

Greater information access may then be provided to the fourth literature review item at block 524 based on movement of the fourth literature review item, the greater information access including greater detailed information not included with the limited information access. In some embodiments, providing greater information access includes generating a user interface including a portion of text of the fourth literature review item highlighted in accordance with the keyword highlighting configuration data.

At block 526, additional review data is then received through a second data entry form in accordance with the data entry methodology and providing of the greater information access to the fourth literature review item.

Literature review report data of the literature review items may be exported at block 528 based on receipt of the initial review data, automatic inclusion of the first literature review item, automatic exclusion of the second literature review item, manual exclusion of the third literature review item, and receipt of the additional review data.

A literature review report of the literature review items may be generated at block 530 based on the receipt of the initial review data, the automatic inclusion of the first literature review item, the automatic exclusion of the second literature review item, the manual exclusion of the third literature review item, and the receipt of the additional review data.

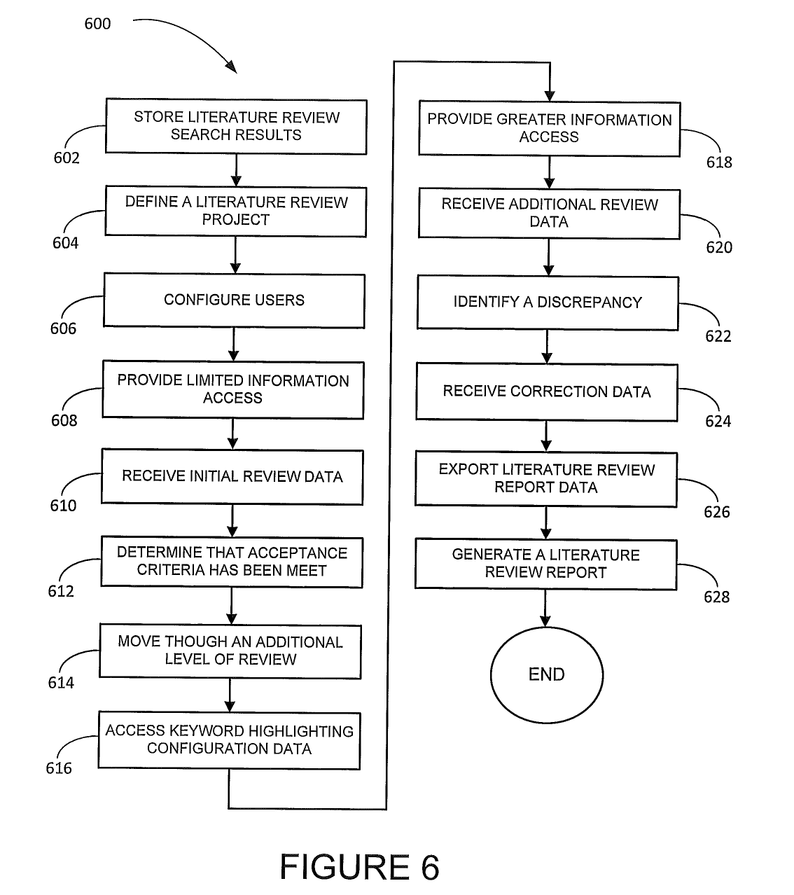

FIG. 6 illustrates an example method 600 for document analysis and processing, according to an example embodiment. The method 600 may be performed by the operator device 102, by the resource device 106, partially by the operator device 102 and partially by the resource device 106, or may be otherwise performed. The method 600 may support a literature reviews performed for a pharmacovigilance activity (e.g., as a regulatory requirement) or as a separate research activity requirement.

At block 602, results from a literature review search about a topic are stored. In some embodiments, a literature review search is conducting across multiple literature sources on the topic to identify the literature review items and the results are then stored as the literature review items 112 in the database 108. In some embodiments, the literature review search is conducted by a first device and the results are then sent transmitted to a second device (e.g., the operator device 102 and/or the resource device 106) for storage in the database 108 and/or directly stored in the database 108 as the literature review items 112.

A literature review project is defined at block 604. In general, defining the literature review project includes receiving and/or storing review criteria for a literature review project, receiving and/or storing a data entry definition of a plurality of data entry forms for the literature review project, and receiving and/or a methodology definition of a data entry methodology. The review criteria generally includes criteria for literature review item inclusion, literature review item exclusion, or literature review item inclusion and exclusion in a study on a topic. The data entry forms are configured in accordance with the data entry definition to receive literature review item analysis information through a multi-level review. The methodology definition generally includes defining a number of per item reviewers for the literature review project. In some embodiments, the methodology definition reflects a double data entry methodology for the literature review project.

The users associated with the literature review project may be configured at block 606. For example, a data entry user may be associated with the literature review project. The data entry user may also be associated with a role in the literature review project.

At block 608, limited information access is provided to a first portion of literature review items identified in a literature review search to a first person and to a second portion of the literature review items identified in the literature review search to a second person.

Initial review data is received at block 610 through the data entry form in accordance with the data entry methodology and providing of the limited information access to the first portion and the second portion of the plurality of literature review items.

At block 612, a determination that a literature review item of the literature review items has met an acceptance criterion may be made based on receipt of the initial review data associated with the fourth literature review item. The literature review item may then be moved through at least one additional level of review at block 614 based on a determination that the literature review item has met the acceptance criterion. In some embodiments, moving the literature review item through at least one additional level of review is performed automatically (e.g., based on the acceptance criterion). In some embodiments, a literature review item movement indication is received and the moving the literature review item through at least one additional level of review is performed on such basis.

In some embodiments, keyword highlighting configuration data is accessed at block 616.

Greater information access may then be provided to the literature review item at block 618 based on movement of the literature review item. In some embodiments, providing greater information access includes generating a user interface including a portion of text of the literature review item highlighted in accordance with the keyword highlighting configuration data.

Additional review data is then received through a data entry form at block 620 in accordance with the data entry methodology and providing of the greater information access to the literature review item.

At block 622, a discrepancy may be identified among the initial review data, the additional review data, or the initial review data and the additional review data received from the first person and the second person. Correction data may be received at block 624 through an additional data entry form in response to identification of the discrepancy.

Literature review report data of the literature review items may be exported at block 626 based on receipt of the initial review data, the additional review data, and the correction data.

A literature review report of the literature review items may be generated at block 628 based on the receipt of the initial review data, the additional review data, and the correction data.

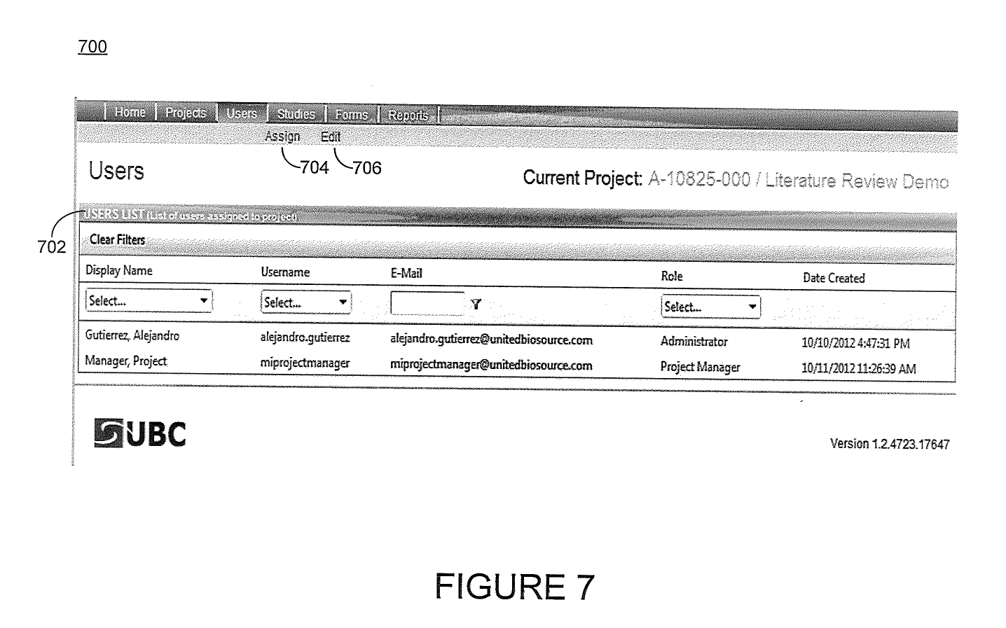

FIGS. 7-33 show various displays consistent with one or more example embodiments. The displays may include images, text, screen shots, and/or user interfaces. One or more than one of these displays may be generated or provided by the document analysis and processing subsystem 202. While various particular implementations, such as input buttons, dialog interfaces, radio buttons, and the like, are described in the example embodiment, various other suitable mechanisms may be utilized for achieving similar results.

Generally referring to FIGS. 7 through 9, users may be associated with a literature review project in various capacities. In general, the operations performed by the user configuration module 406 provide the functionality reflected through displays 700-900. As generally described above, a literature review project may include the review and extraction of information from a collection of literature review items 112 related to a common review topic, which can be stored in the database 108. In the example embodiment, the literature review project may include one, or several, reviewers who may review the various literature review items 112 and may extract and document information from the various literature review items 112 through the document analysis and processing subsystem 202. The document analysis and processing subsystem 202 may receive input from the reviewers and apply rules, which can be stored instructions, to the literature review items 112 and store the results within the project data 110.

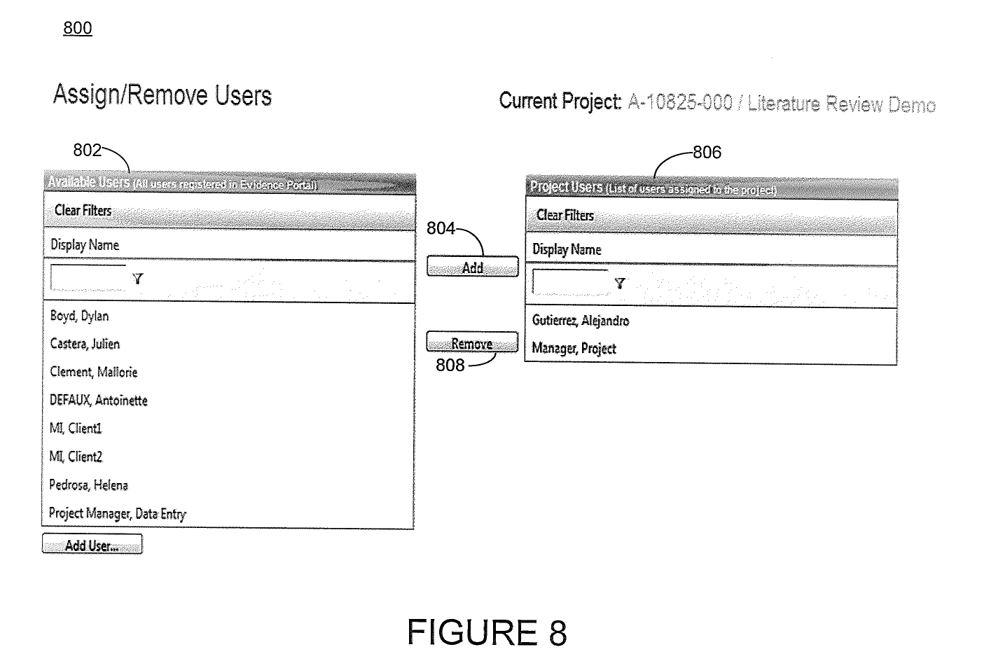

As shown, FIG. 7, a display 700 as generated by the user configuration module 406 may indicate the users currently associated with a given literature review project, for example, in the user list 702. A device operator of the operator device 102 or the resource device 106 (e.g., in which the device operator is an individual having sufficient permissions or privileges for configuring a literature review project) may add one or more than one additional users to be associated with the literature review project by selecting the “Assign” option 704. The assign option causes the document analysis and processing subsystem 202 to provide instructions within the document analysis and processing subsystem 202 to allow the device user to select and link the additional user to the literature review project. Similarly, the permissions or privileges may be changed, by selecting the “Edit” option 706. Like the assign option, the edit option causes the document analysis and processing subsystem 202 to provide instructions within the document analysis and processing subsystem 202 to allow the device user to change permission and/or privileges for an additional user within the literature review project. For example, and referring also to FIG. 8, in response to a device operator selection the “Assign” option 704, a display 800 may be generated by the user configuration module 406 and include a list of available users 802 who may be selected and added to the literature review project, by selecting the add option 804. The list of available users 802 can be stored within the project data 110. In a related manner, one or more than one users may be removed from the literature review project by selecting the desired user from the list of current project users 806 and selecting the remove option 808. This results in that user not having permission or privileges related to that project. The links of users to projects, the permissions and privileges may all be stored as project data 110.

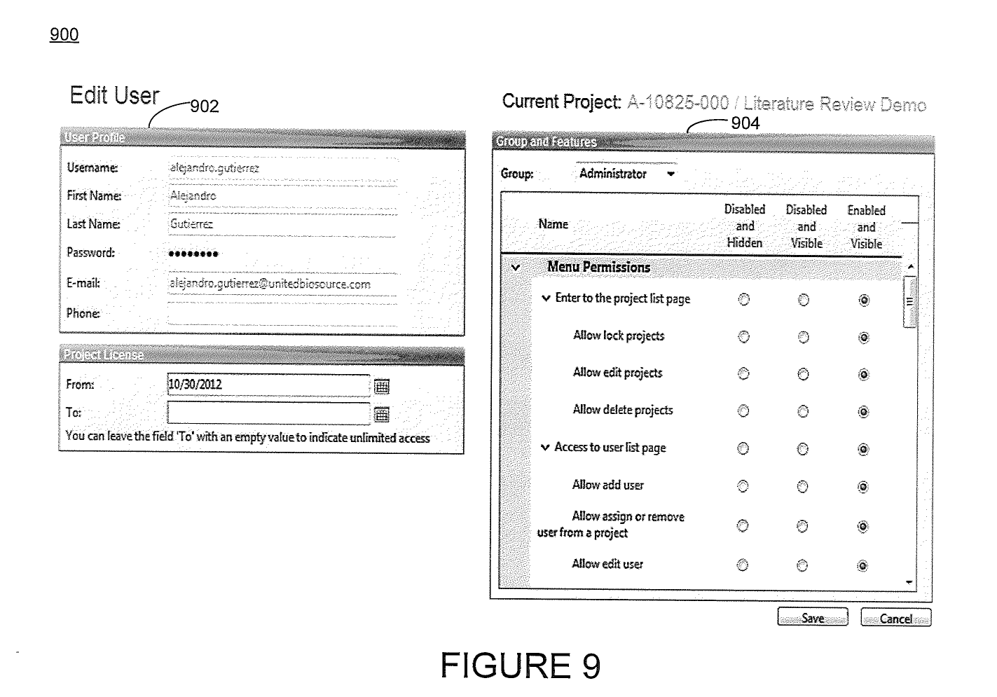

FIG. 9 includes a display 900 as generated by the user configuration module 406 that shows that the privileges or permissions associated with a user assigned to a literature review project may be edited, for example, by selecting the “Edit” option 704 from within the display shown in FIG. 7. For example, by way of a display 900, user profile information to be defined, e.g., by the device operator entering the desired user profile information into to a user profile dialog 902. Examples of user profile information may include, but are not limited to, username, first and last name of the user, access password, e-mail address, and telephone number. Additionally, permissions and/or privileges may be assigned for a user associated with the literature review project via a dialog interface 904. For example, the dialog interface 904 may allow a device operator to define a group for the user (e.g., administrator, reviewer, data entry, etc.). Similarly, the dialog interface 904 may allow the device operator to select various permissions that may be associated with the selected user, such as by selecting option radio buttons associated with various listed or indicated permissions or activities. Selections and data entries may be received through the user configuration module 406.

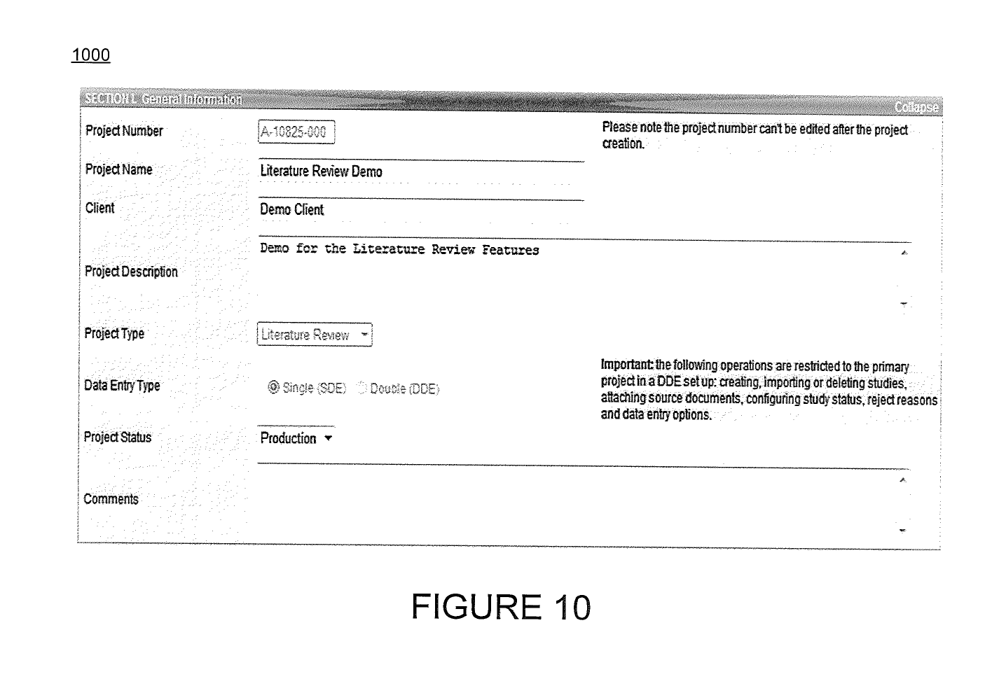

FIGS. 10 through 15 show the displays 1000-1500 respectively. In general, the operations performed by the project definition module 404 provide the functionality reflected through displays 1000-1500. As shown in these displays 1000-1500, a device operator may have sufficient permissions or privileges with respect to a given literature review project to define various attributes, parameters, and features of the literature review project. Such permissions or privileges can be verified by the project definition module 404 by applying rules to data associated project data 110. The attributes, parameters, and features of the literature review project may, generally, define the type of information that may be collected for the various individual literature review items 112, the manner in which the information may be collected for the various individual literature review items 112, and parameters for including, or excluding, a given literature review item 112 from the literature review project through use of the inclusion exclusion module 412. Various additional and/or alternative features may also be defined for the literature review project.

FIG. 10 includes a display 1000 generated by the project definition module 404 that shows that a device operator may define various general information regarding a literature review project. For example, as shown in FIG. 10, the display 1000 may allow the device operator to define a project number and name associated with the literature review project. Similarly, the device operator may define a client for whom the literature review is being conducted, as well as a description of the literature review project. Such information may, for example, allow literature review projects to be distinguished from one another, as well as allowing a user to understand at least certain aspects of the literature review project. Such definition operations can be performed by the project definition module 404 and stored as a portion of the project data 110.

The display 1000 may also provide an interface that allows the device operator to define a data capture methodology that may be implemented with respect to the literature review project. For example, the device operator may select, e.g., via the radio buttons, that the data enter by conducted using either a single entry methodology or a double entry methodology. In general, the data entry methodology may determine a level of quality assurance imposed on data entered during the course of the actual review of the literature review items 112. For example, a single data entry methodology may allow for a single user to enter data only once. A double data entry methodology may require that two users separately enter each piece of data. Further, the double data entry methodology may allow for a comparison of the data entered by each user and an identification and resolution of any discrepancies between the data entered by each user. As such, the double date entry methodology may provide a higher degree of reliability in the entered data, but may also greatly increase the required resources (e.g., data entry man hours) necessary to complete the review, as every literature review item may be reviewed by two separate users. In some implementations of single data entry, at least a portion of the data entered by the single user may be subject to verification by a second user, e.g., to provide a higher degree of reliability in the entered data. In some embodiments, the detection of discrepancies is fully automated. A user may then manually define the right value and the discrepancy module 416 applies it to both versions of the data.

In some embodiments, the level of quality assurance may include single data entry where each data item is entered by one person and no revision is enforced, single data entry with review where for, example, a second person has the chance to review and correct/reject the data entered by the initial user, and double data entry where two different persons enter the same data elements independently, a later comparison is automatically performed identifying discrepancies for resolution.

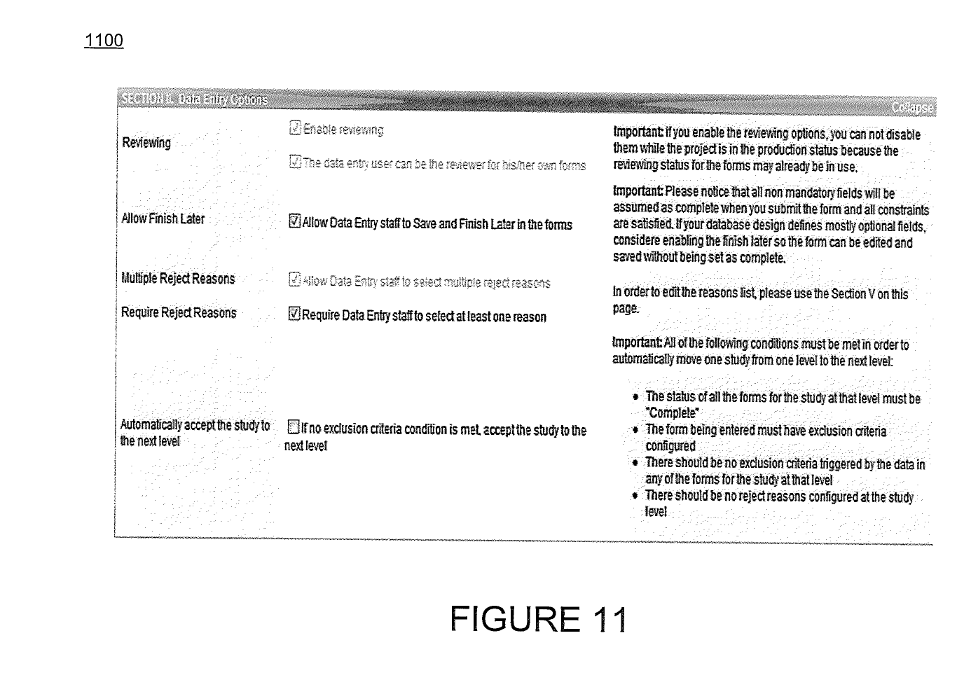

FIG. 11 shows a display 1100 generated by the project definition module 404 that may allow various data entry options to be defined for the literature review project. Examples of data entry options may include options for reviewing entered data. For example, and as generally described above, for a single data entry methodology some level of review of the entered data may be implemented. Review of entered data may be required by selecting the “Enable reviewing” option from within the display 1100. Similarly, the display 1100 may allow the device operator to determine whether the user entering the data may also conduct the review of the entered data through the information access module 408, with review information being received through the review data collection module 410. Additional review options may be defined, for example, the extent to which, or amount of, entered data should be reviewed, specific data items that should be reviewed, or the like. The data entry options may be stored as a portion of the project data 110.

The display 1100 may also permit the device operator to define whether a data entry form must be completed in a single session, or whether a data entry user can save a partially completed form and finish it later. For example, in the case of large data entry forms, it may not always be practical to complete the entire form in one session due to the number of data items to be entered or the scope of review that may be required to complete the data entry form. In other situations, it may be considered desirable for a data entry form to be completed in a single session, for example, such that all necessary information may be fresh in the data entry user's mind at the time the data entry form is completed. Such information may be stored through the project definition module 404 as a portion of the project data 110.

The display 1100 may also permit the device operator through the project definition module 404 to define rejection options for literature review items 112 included within the literature review project. The rejection of a literature review item 112 from the literature review project may, for example, indicate that the literature review item 112 may not be considered in the ultimate analysis or evaluation that may include only the literature review items 112 accepted through the literature review process. For example, if a literature review project is interested in evaluating the side effects of a drug on males between the ages of 20 and 40, a literature review item 112 regarding the drug and a combined male and female test population having an age range of 40 to 60 may be excluded because it does not differentiate effects of the drug between men and women, and/or because the test populate extends outside of the age range of interest. As such, the findings of the literature review item 112 may not be considered relevant to the scope of the literature review project. Examples of rejection options for literature review items 112 may include the ability to accept multiple reasons for rejecting a literature review item 112 from the literature review project, and the requirement that a data entry user provide a reason for rejecting the literature review item 112 from the literature review project. Additionally, the display 1100 may include an option to automatically accept a literature review item 112 through use of the leveling module 414 to a next level of review if no exclusion criteria are provided for a literature review item. That is, if a literature review item 112 is not excluded from the literature review project, it may be automatically included without requiring a specific action to include the literature review item 112 through use of the inclusion exclusion module 412.

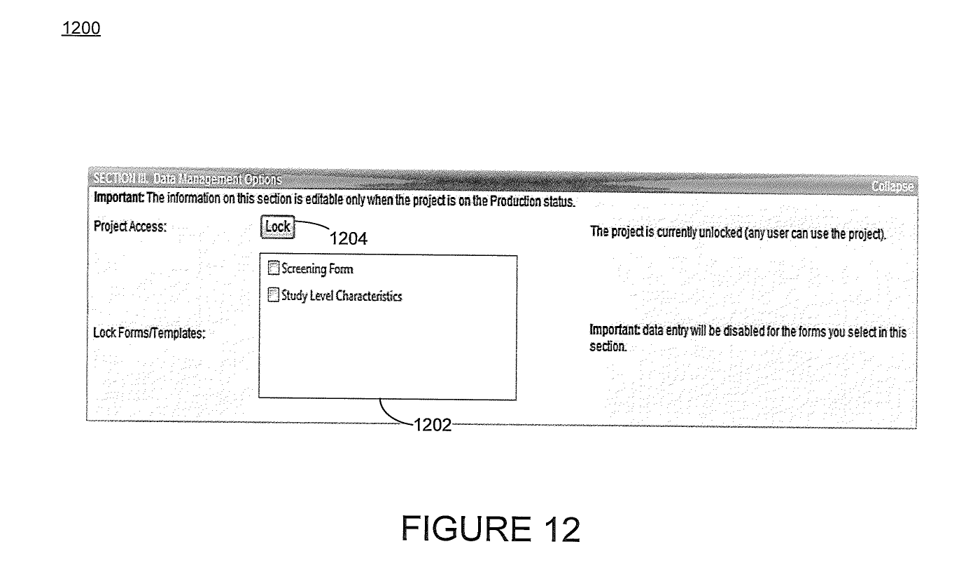

FIG. 12 shows a display 1200 generated by the project definition module 404 that reflects that the device operator may restrict actions with respect to a literature review project. For example, the device operator may select one or more than one data entry forms from within the form list 1202 and may select the “Lock” option 1204 to lock the selected data entry forms (or even the entire literature review project) from editing. Locking the one or more data entry forms (or the entire literature review project) from editing may prevent entry of data into the selected form, or editing of data that may have already been entered into the selected form.

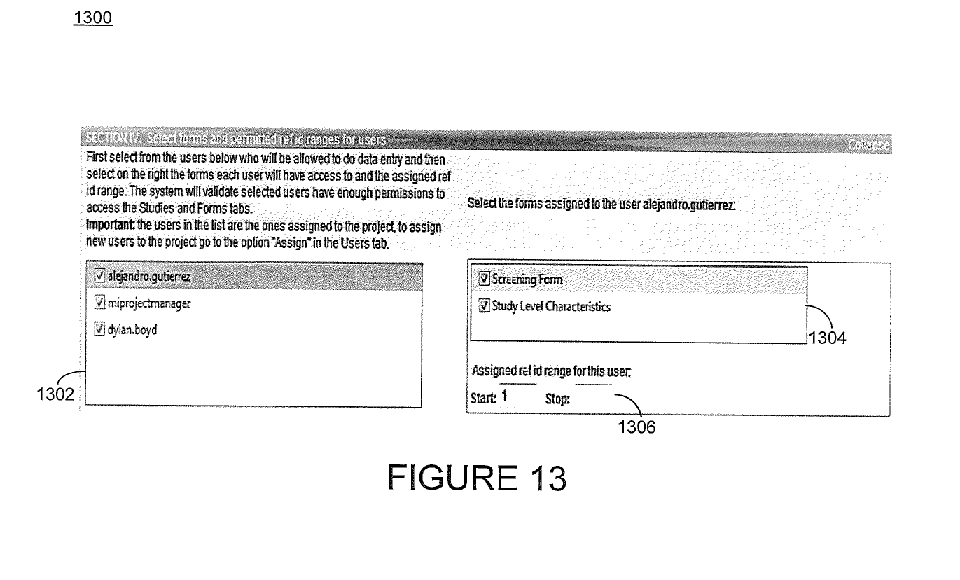

FIG. 13 shows a display 1300 generated by the project definition module 404 that reflects that specific user's permission to enter data into specific data entry forms may be assigned. For example, the device operator may select one or more than one users from the user list 1302, and may select one or more than one data entry forms from the form list 1304. In general, a data entry from may allow a data entry user to enter one or more than one pieces of information regarding a literature review item 112. As such, the display 1300 may allow the device operator to select which users or user devices may enter data into which data entry forms. For example, different forms may be specialized and require a specific or particular type of data. Abstracting the specific or particular types of data may, in some instances, require particular knowledge or background by a user in order to increase the likelihood that the information will be correctly understood and entered into the data entry form. As such, the device operator may select data entry users having the necessary knowledge or background for entering data into a particular data entry form via the display 1300. In addition to assigning permissions for specific users to enter data into specific data entry forms, the display 1300 may also allow the device operator to identify specific literature review items 112, or blocks of literature review items 112, that may be reviewed by a specific user using reference range inputs 1306. For example, as discussed above, a collection of literature review items 112 may include hundreds or thousands of individual literature review items 112. As such, the literature review items 112 may be divided amongst multiple data entry users to increase the speed at which the literature review project may be completed. Each of the data entry users may be assigned a specific block of literature review items 112 to reduce or eliminate redundant review of literature review items by more than one data entry user, except in the case of the double data entry.

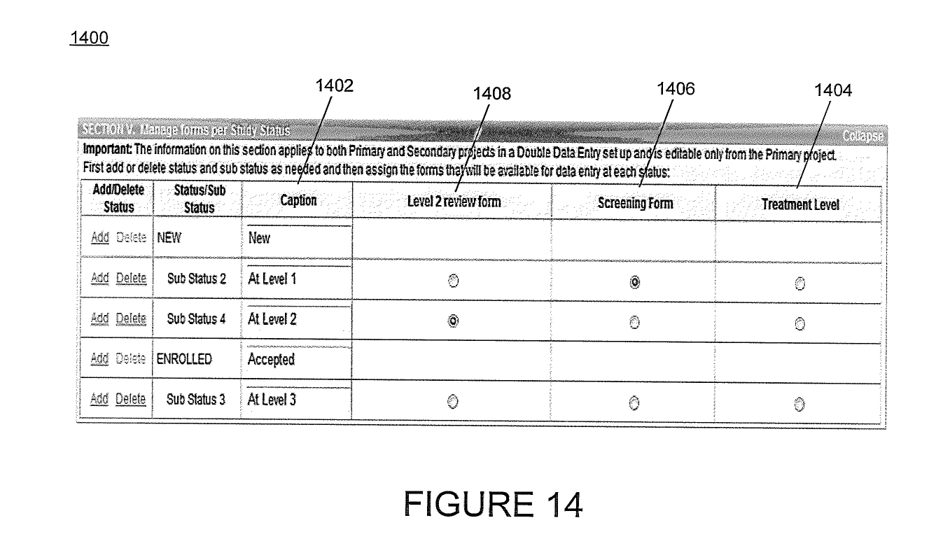

FIG. 14 shows a display 1400 generated by the project definition module 404 that reflects that the device operator may define different levels of review that a literature review item may undergo during the course of the literature review process. The different levels of review may relate to where the literature review item stands in the review process, and what review activities have been carried out with respect to the literature review item. That is, one or more specified review processes may be carried out on a literature review item at each level. For example, in the column “Caption” 1402 the various levels for a literature review item may be indicated, namely “New,” “At Level 1,” “At Level 2,” “Accepted,” and “At level 3.” Further, the display 1400 may indicate the various data entry forms that may be utilized in connection with reviewing a literature review item 112, and the level at which the data entry form may be utilized. In the example, three data entry forms, the “Treatment Level” form 1404, the “Screening Form” 1406, and the “Level 2 review form” 1408 may be defined. As shown, the “Screening Form” 1406 may be utilized at level 1 and the “Level 2 review form” 1408 may be utilized at level 2. That is, at level 1 the data specified in the “Screening Form” 1406 may be abstracted from the literature review item 112 by a data entry user and may be entered into a data entry form entitled “Screening Form”. As such, the various pieces of information regarding, or included within, the literature review item 112 that are specified in the form entitled “Screening Form” may be determined by the data entry user reviewing the literature review item 112 and may be entered into appropriate data entry fields within the “Screening Form”. Similarly, at level 2 the various pieces of information regarding, or include within, the literature review item 112 that are specified in the form entitled “Level 2 review form” may be determined by the data entry user reviewing the literature review item an may be entered into the form entitled “Level 2 review form”.

While only three forms are shown as being used in FIG. 14, any number of data entry forms may be used during the course of a literature review project. The different data entry forms may require that different pieces of information regarding, or included within, each literature review item 112 be collected by a data entry user, and be input into an appropriate field within the different data entry forms. Accordingly, different information available from the various literature review items 112 may be collected. Additionally, in some embodiments, by associating different data entry forms with different levels of review, various different types of information can be abstracted from each literature review item 112 to determine if the literature review item 112 should be included within the study for which the literature review is being conducted. For example, if scope of the study is only directed at the effects of a drug on males between the ages of 20 and 40, a literature review item 112 relating the effects of the drug on women between the ages of 30 and 60 would not be of interest. Review conducted at one level may exclude such a literature review item 112 prior to a more extensive review being conducted at a subsequent level. As such, resources (such as man hours of review time) may be conserved by excluding literature review items 112 that are outside of the scope of the study prior to conducting a detailed review and analysis of the document.

Data entry forms (e.g., which may be associated with different levels of review within the literature review project) may be defined according to various suitable mechanisms. In general, the data entry forms may take a variety of different configurations, but may generally include, for example, information labels that may identify the pieces of information that should be abstracted from the literature review item 112, and may include corresponding data entry tools, which may allow a data entry user to enter the abstracted information. The data entry tools may include various suitable tools, such as text entry boxes, pull-down menus, or the like, which may allow a user to enter the desired pieces of information requested by the data entry form. For example, an initial screening form may include the information label “publication date” indicating that the data entry user should input the date that the literature review item was published. Further, the data entry form may include a text input box, allowing the data entry user to manually type in the publication date of the literature review 112 item. In some embodiments, a pull-down menu may allow the data entry user to select a publication date from a list of years, months, and/or days. Various different pieces of information may be abstracted from the literature review items 112 by the data entry users and may be captured by the data entry forms (e.g., via user inputs) through use of the review data collection module 410.

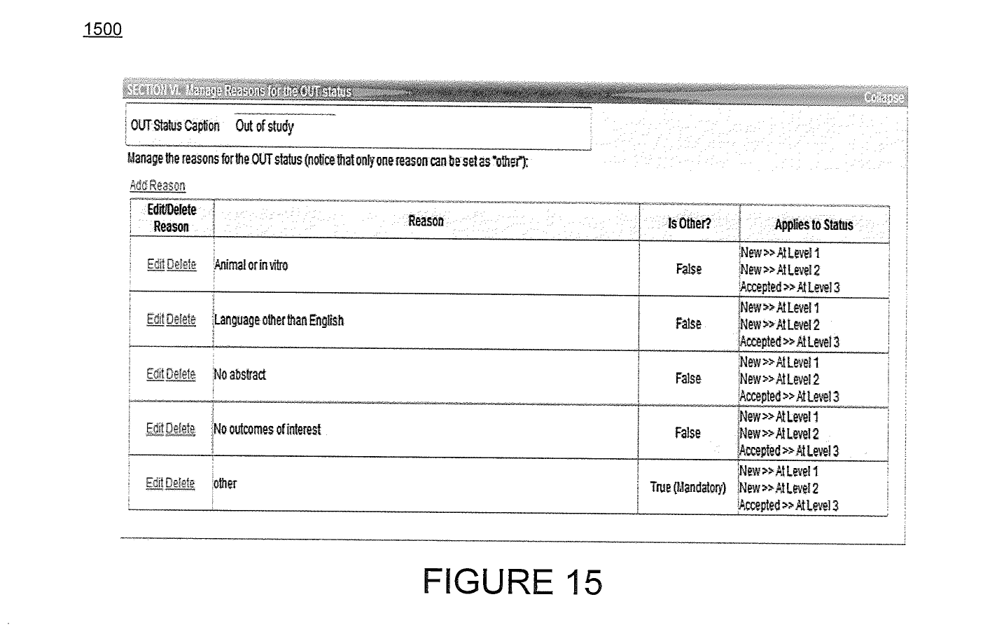

FIG. 15 depicts a display 1500 generated by the project definition module 404 that may allow a device operator to define exclusion criteria, by which a literature review item 112 can be excluded from a study. Defining, and providing documentation, different bases of excluding a literature review item 112 of a study may allow the integrity of a study to be maintained, for example, by being able to identify a valid reason that the literature review item 112 was excluded which is based on the nature or scope of the study. In addition to defining criteria, or reasons, for excluding a literature review item 112 from the study, the display 1500 also reflects that the device operator may define the review level, or levels, at which the various exclusion criteria may be applied for excluding the literature review item from the study. As such, the exclusion criteria may only be used to exclude the literature review item 112 from the study if the exclusion criteria are indicated at the appropriate level of the literature review. Associating exclusion criteria with different review levels may, for example, facilitate re-filtering at different review levels to apply, or remove, various exclusion criteria as a basis for excluding the literature review item 112 from the study. In an embodiment, the various exclusion criteria may be presented to a data entry user (e.g., on a data entry form associated with the level for which the exclusion criteria is defined). As such, if the exclusion criteria are determined to be applicable by the data entry user during the course of the review of a literature review item 112, the data entry user may select the exclusion criteria as a basis for excluding the literature review item 112 from the study. In some embodiments, no further data entries may be made with respect to the excluded literature review item 112. In other embodiments, further data entry may be made with respect to the excluded literature review item 112.

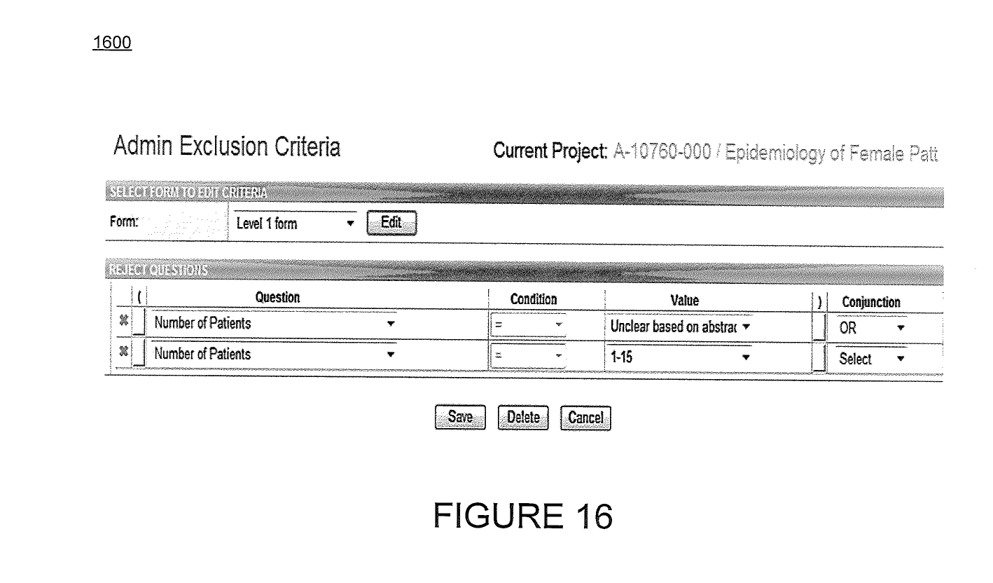

FIG. 16 depicts a display 1600 generated by the project definition module 404 through which the device operator may define automatic exclusion criteria. In an embodiment, one or more than one of the automatic exclusion criteria may be based upon, at least in part, information that may be abstracted by the data entry user and entered into a data entry form. As such, the defined automatic exclusion criteria may provide a logic by which the inclusion exclusion module 412 may automatically exclude the literature review item 112 from the study. For example, only literature review items 112 pertaining to research involving greater than 16 patients may be considered of sufficient merit to be considered in the study. A data entry form may require that the data entry user abstract the number of patients involved in the research of a literature review item 112 and enter the number of patients in the data entry form. In the illustrated example, the display 1600 shows defined automatic exclusion criteria for literature review items 112 for which the number of patients is unclear based on the abstract, or for literature review items 112 having between 1 and 16 patients. As such, in response to a data entry user entering a number of patients less than 16 into a data entry form, or indicating that the number of patients is unclear based on the abstract, the literature review item 112 may be automatically excluded from the study. Various additional and/or alternative automatic exclusion criteria may be defined.

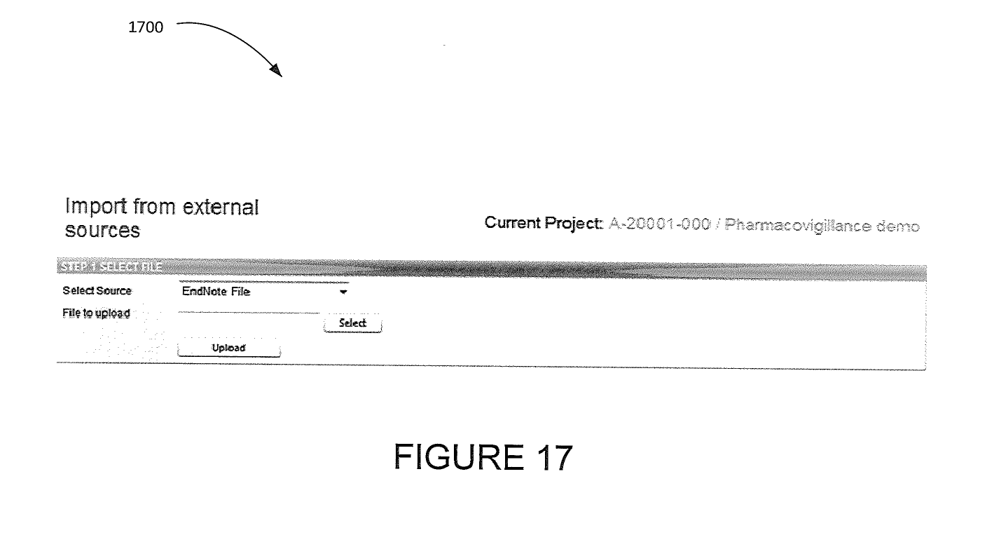

FIG. 17 shows a display 1700 generated by the search module 402 that reflects an initial upload of the literature review items 112 found in the search performed. The upload may take as input a file containing the basic information of the literature review items 112 as obtained from the original source. The import or upload may include an automatic or semi-automatic control of duplicate literature review items 112 being uploaded.

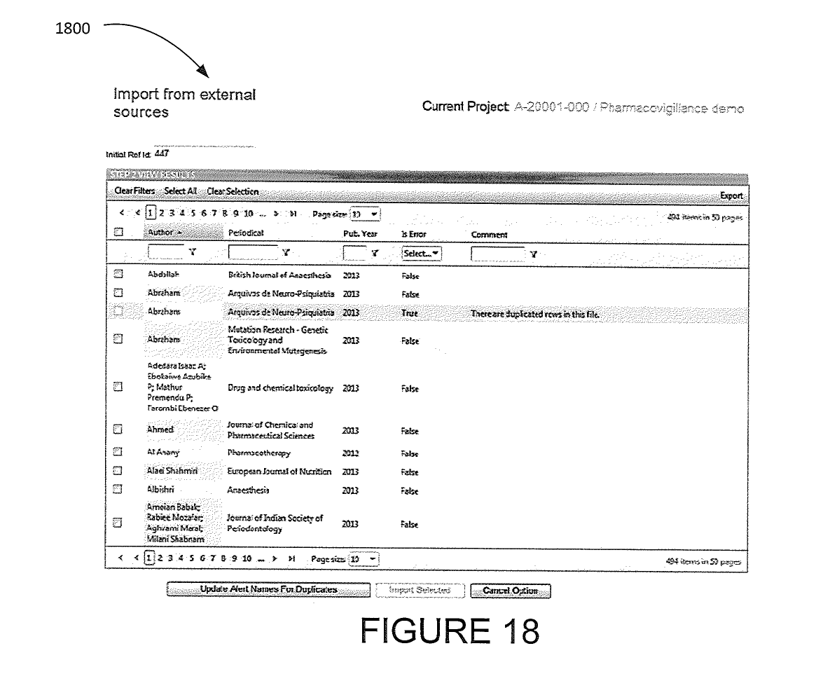

FIG. 18 shows a display 1800 generated by the search module 402 that reflects upload of the full text version of the literature review items (e.g., as PDF files) to allow a complete reading of the literature review items 112. In some embodiments, the initial upload includes only the reference information and the abstracts. The upload may make an automatic association of the file uploaded to the literature review item 112 in the database 108 by using some key fields (e.g., author, year, journal, and/or pages). In case a partial match is identified with these parameters, the user may decide whether the file indeed matches the literature review item 112 or not.

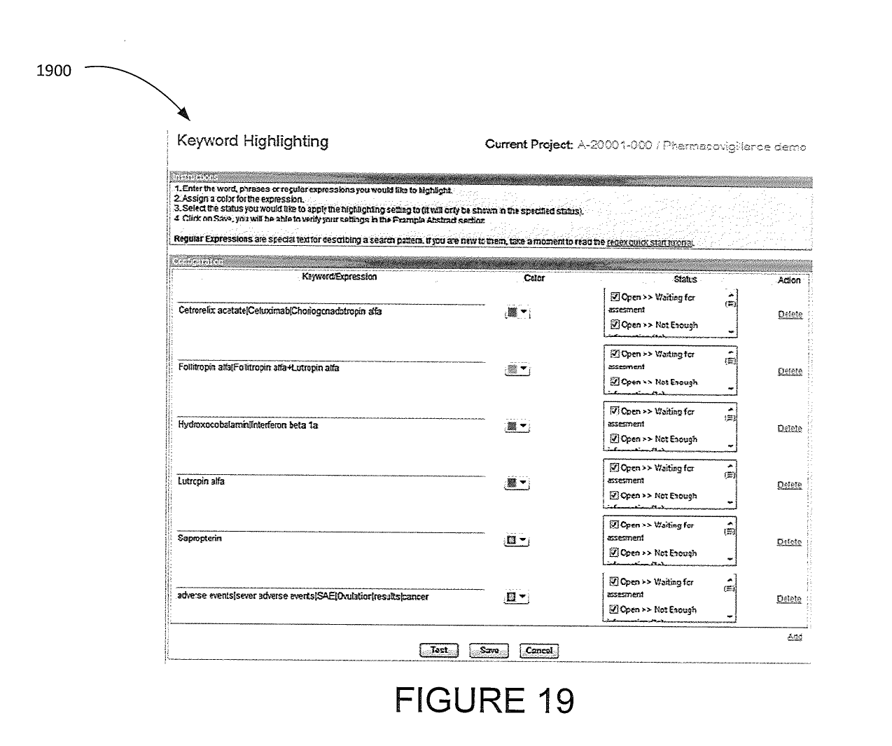

FIG. 19 shows a display 1900 generated by the emphasis module 422 that reflects configuration of keyword highlighting. In general, keyword highlighting allows the device operator to define words or regular expressions to be searched when presenting the literature review items 112. When these words or regular expressions are found, they may be highlighted in a color defined by the user to make them immediately visible for the reviewer when they are present. The color code may facilitate a quicker evaluation of keywords in the literature review items 112. A different set of keyword highlighting settings may be defined for each revision level.

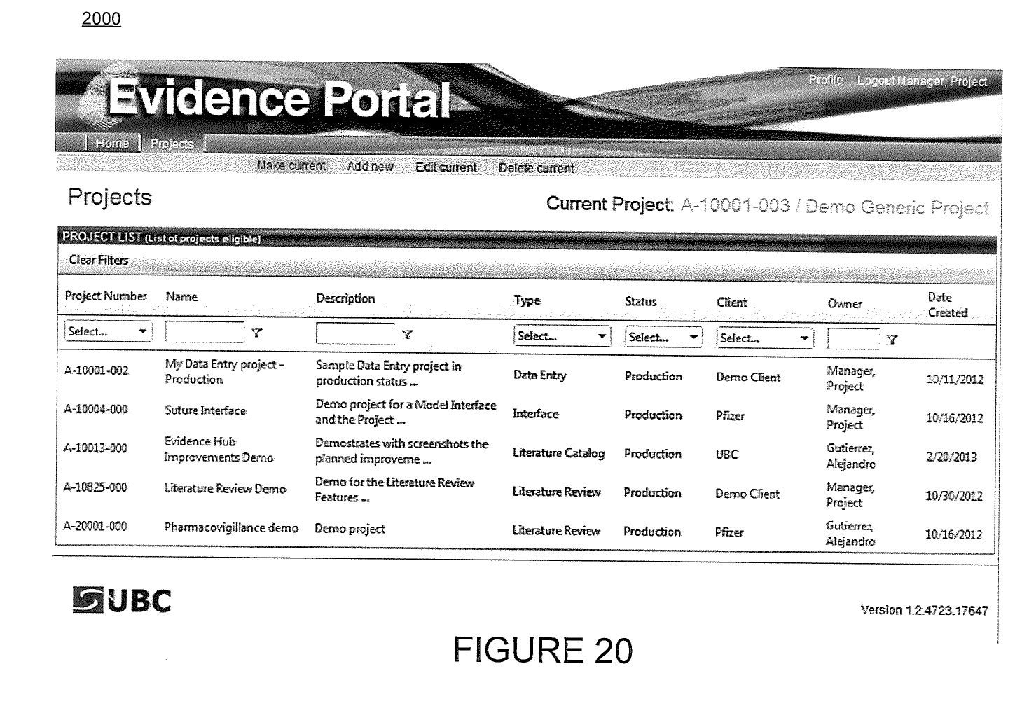

FIG. 20 depicts a user access display 2000 generated by the document analysis and processing subsystem 202, via which a user, once logged on, may access one or more than one literature review projects for which the user has been granted authorization to view, edit, manage, or the like. The user may include, for example, a device operator having some degree of administrative privileges for defining or managing a literature review project, or may include a data entry user, e.g., who may only have privileges to review literature review items and enter data relative to the reviewed literature review items 112. Selecting a listed project from within the display 2000 may allow the user to access one or more than one of the features of the selected literature review project.

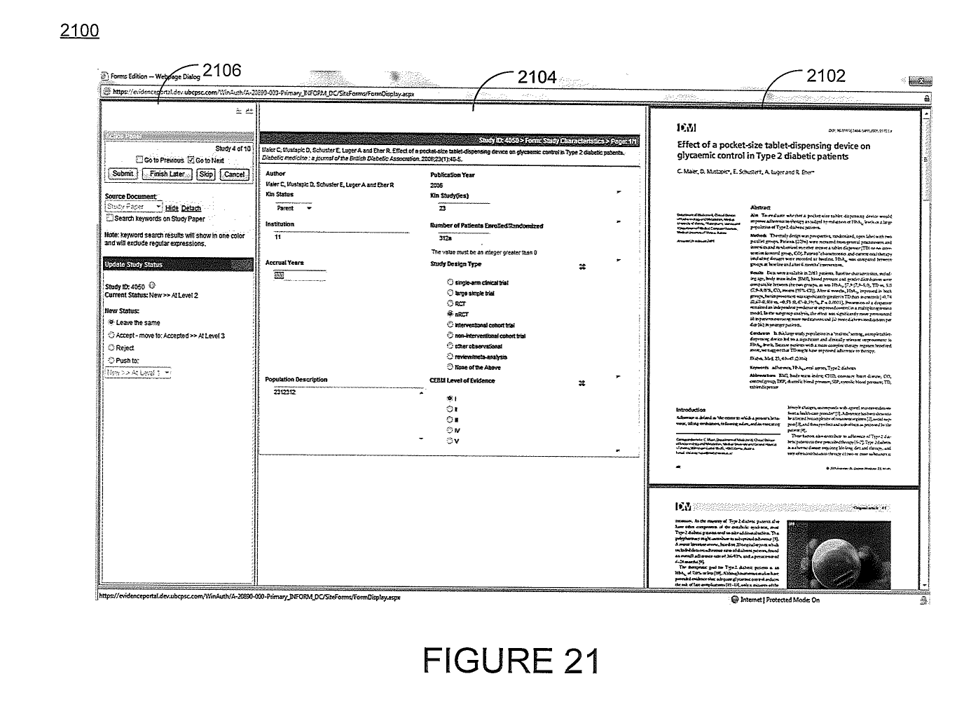

FIG. 21 shows a display 2100 generated by the information access module 408 that reflects an example document review display. In the illustrated embodiment, the data entry display may include three panels (e.g. that may be displayed within a single window and/or within two or three windows, and/or displayed across multiple monitors). A first panel of the data entry display may include a literature review item display 2102 including the literature review item 112 being reviewed. Various controls may be provided for navigating the literature review item 112, such as scrolling controls, searching options, saving and printing options, or the like, as may be commonly understood. The literature review item 112 may be provided as an electronic document, such a PDF document, or other electronic document. The data entry user may use the navigation controls to review and abstract the literature review item 112 relative to data items requested in the data entry panel 2104.

The data entry panel 2104 may include one or more than one data entry forms that may have been defined for collecting data from the literature review items 112 for the literature review project. As discussed above, a data entry form for a literature review project may include various data items to be filled in by the data entry user based on the information regarding, or included within, the literature review item 112. For example, in the example data entry form shown in the data entry panel 2104 of the display 2100, requested data items may include “Author” of the data item, “Publication Year,” as well as various other pieces of information. The data entry user may review the literature review item 112 in the literature review item display 2102 to identify the pieces of information requested by the data entry form included within the data entry panel 2104. In an embodiment, each completed data entry form may be associated with the particular corresponding literature review item 112 (e.g., by being stored as the project data 110 within the database 108, or the like). As such, the entered data may be correlated with the literature review item 112 from which the information was abstracted. In some embodiments, the data entry forms may be fully validated to be Title 21 C.F.R. Part 11 compliant for maintaining confidentiality of medical records and/or other applicable provisions.

The document review display 2100 may also include an action panel 2106. The action panel 2106 may include various actions that may be taken by the data entry user, e.g., using one or more of the devices 102, 106. Examples of actions that may be taken by the data entry user from within the action panel 2106 may include, but are not limited to, submitting data entered into the data entry form currently displayed within the data entry panel, skipping the data entry form currently displayed within the data entry panel 2104, electing to finish the data entry form at a later time, accepting or rejecting the literature review item 112, moving the literature review project for the literature review item 112 to the next level, or the like.

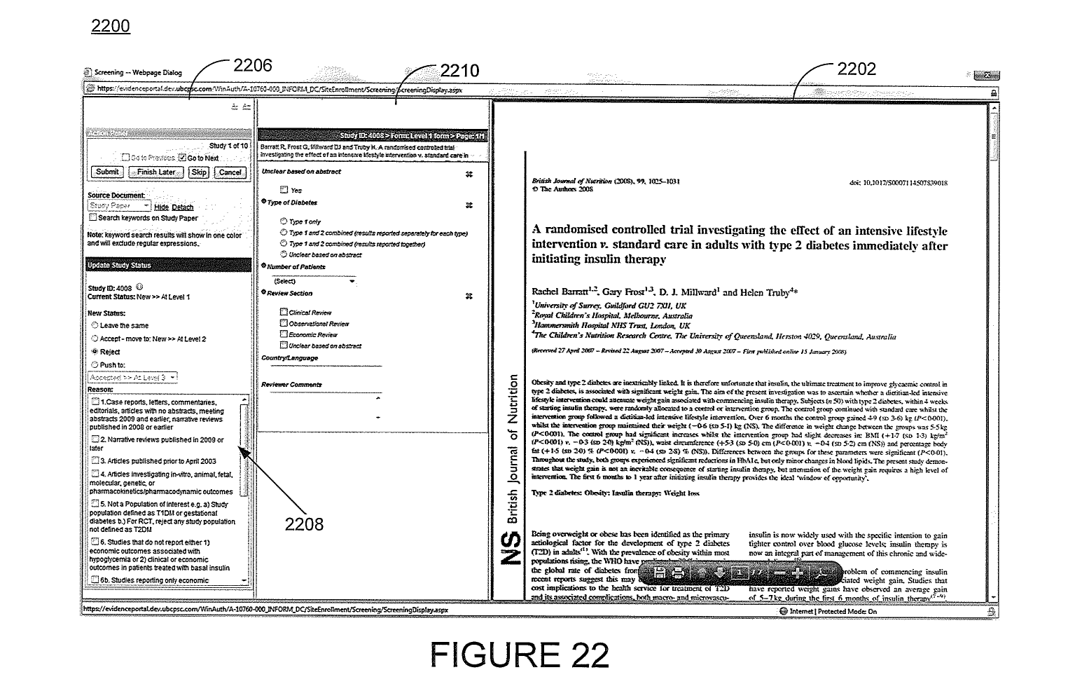

In an example embodiment, in response to the data entry user selecting the reject option from within the action panel of the document review display 2100, the information access module 408 may generate a rejection reason menu 2208 within the action panel 2206 of the document review display 2200, as shown in FIG. 22. The rejection reason menu 2208 may include a list of valid reasons for manually rejecting a literature review item 112 from the study. The data entry user may select one, or more than one (e.g., depending upon the defined protocols for the literature review project, as discussed above), of the listed reasons for rejecting the literature review item 112 from the list. In response to the data entry user selecting a reason for rejecting the literature review item 112 from the study, a rejection validation panel 2210 may be displayed. The rejection validation panel 2210 may include one or more than one data entry fields, whereby the data entry user may enter information supporting the basis of the manual rejection of the literature review item 112 from the study. The number and nature of the data entry fields for supporting the basis of the manual rejection may vary depending upon the nature of the rejection. The rejection data entry fields may generally be defined by a device operator in a manner similar to defining the data entry forms, as described herein.

As discussed above, depending upon the defined protocols for the literature review project, data may be collected using a double data entry methodology, in which two reviewers (data entry users) may review the same literature review item 112 and enter the data into appropriate data entry forms. The double data entry methodology may be implemented, for example, to increase the reliability of the entered data. For example, the data entered by each of the two data entry users may be compared to one another to identify discrepancies, e.g., which may indicate that one or both of the data entry users has incorrectly entered a data item.

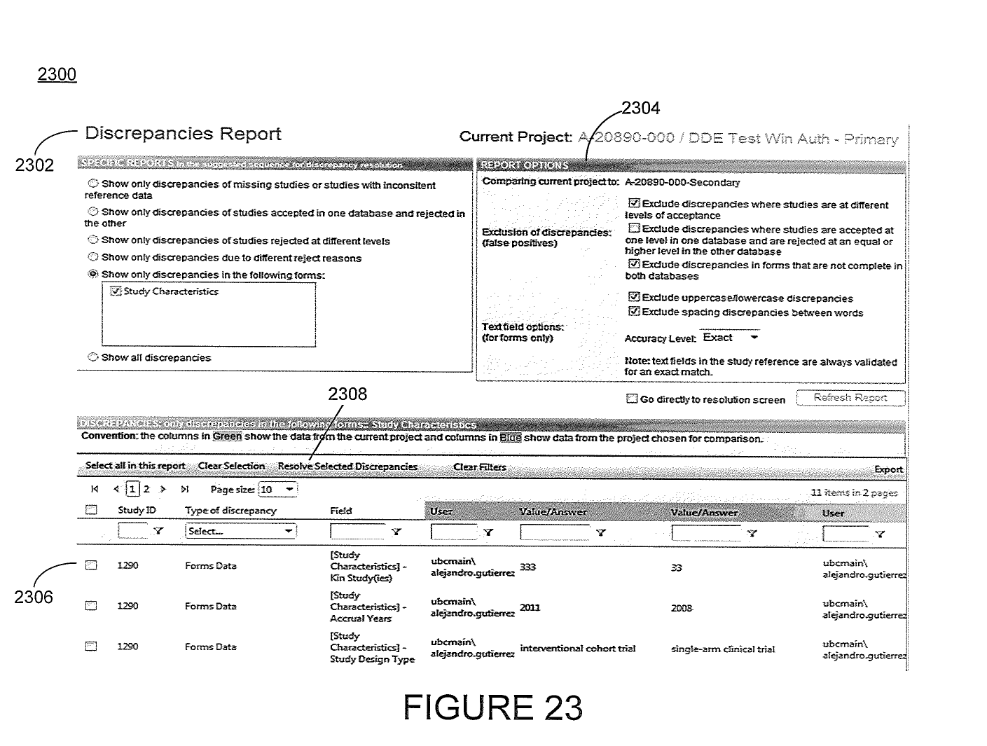

FIG. 23 shows a discrepancies report display 2300 generated by the discrepancy module 416. The discrepancies report display 2300 may include a report type pane 2302, which may allow the device operator to indicate the types of discrepancies that should be reported on, e.g., by selecting check boxed associated with available discrepancy type options, or via another suitable mechanism. For example, in a double data entry methodology discrepancies may arise in the data that is actually entered by the two data entry users and the entered data differs. Similarly, discrepancies may arise in the reasons that a literature review item 112 has been rejected from the study, or in that one data entry user rejected the literature review item 112 while the other data entry user did not reject the literature review item 112. Further, discrepancies may arise from one data entry user passing the literature review item 112 to a different level than the level to which the other data entry user passed the literature review item 112 (e.g., after completion of a common data entry form, or the like). The various discrepancy report types may be selected by the device operator to achieve a discrepancy report that is tailored to the discrepancy type of interest.

The discrepancies report display 2300 may also include a report options pane 2304. The report options pane 2304 may allow the device operator to specify the levels of accuracy that are desired for detecting discrepancies in the double data entries. For example, report options may be provide for excluding discrepancies in studies that are at different levels of acceptance, for excluding discrepancies where a literature review item 112 is accepted at one level, but rejected at an equal or higher level, for excluding discrepancies between incomplete data entry forms, for excluding discrepancies based on case sensitivity or space. Various additional and/or alternative options may be provided for selecting a desired level of accuracy for determining discrepancies between double data entries. The various options provided by the report options pane 2304 may be selected using any suitable mechanisms, such as user selectable check boxes, etc.

The discrepancies report display 2300 may also include a report pane 2306. The report pane 2306 may include the actual discrepancies report based on the selected report types and report options. The report pane 2306 may include a list of all of the discrepancies, as well as the different data provided by each of the data entry users. Further, the report pane may 2306 identify the data field in which each discrepancy occurs. The device operator may select one or more the one discrepancy, for example, by selecting a check box associated with the desired discrepancies or via another suitable mechanism. Further, the device operator may select the “Resolve Selected Discrepancies” option 2308 from within report pane 2306.

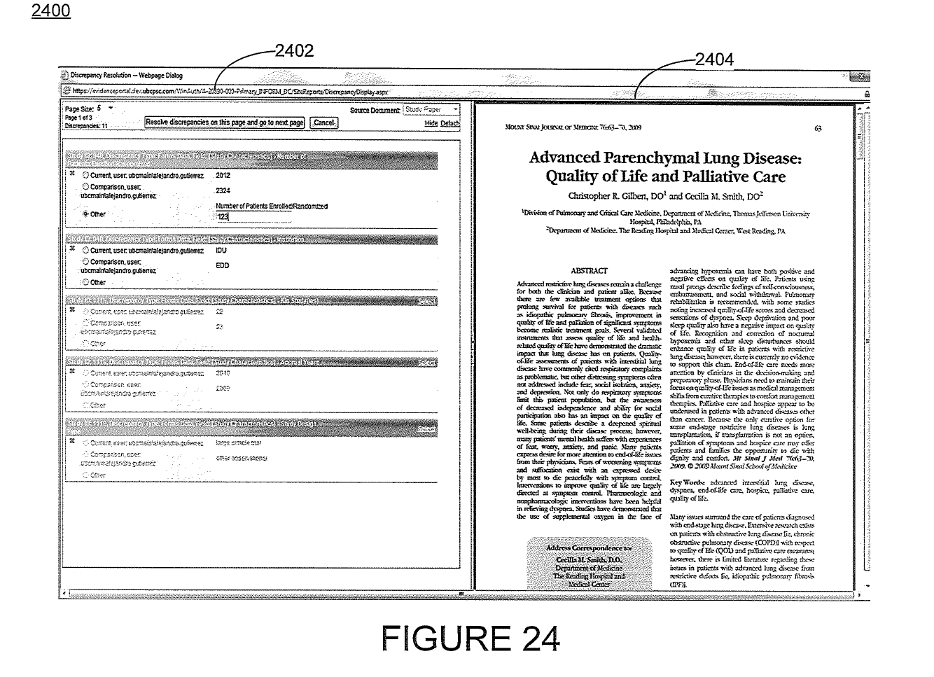

In response to selection the “Resolve Selected Discrepancies” option 2308, a discrepancy resolution display 2400 as generated by the discrepancy module 416 may be provided, as shown in FIG. 24. The discrepancy resolution display 2400 may allow a device operator having an appropriate level of authorization to resolve the discrepancy, e.g., by reviewing at least a relevant portion of the literature review item 112 associated with the discrepancy, and selecting the correctly entered data item, or entering a correct data item (e.g., if both data entries are incorrect). For example, as shown, the discrepancy resolution display 2400 may include a discrepancy pane 2402, which may identify the field or data item in which the discrepancy occurred. The discrepancy pane 2402 may also include the two different values that were entered by each of the data entry users. Further, the discrepancy resolution display 2400 may include a literature review item pane 2404, which may include an electronic copy of the literature review item 112 with which the discrepancy is associated. The literature review item pane 2404 may include navigation controls, e.g., which may allow the device operator to navigate through the literature review item 112 to abstract the literature review item 112 relative to the discrepancy, and to input the correct information within a data entry box included in the discrepancy pane 2402. In some embodiments, discrepancy resolutions may be tracked by the discrepancy module 416 through an auditing functionality, e.g., which may facilitate later review of the discrepancies that occurred and how the discrepancies were resolved.

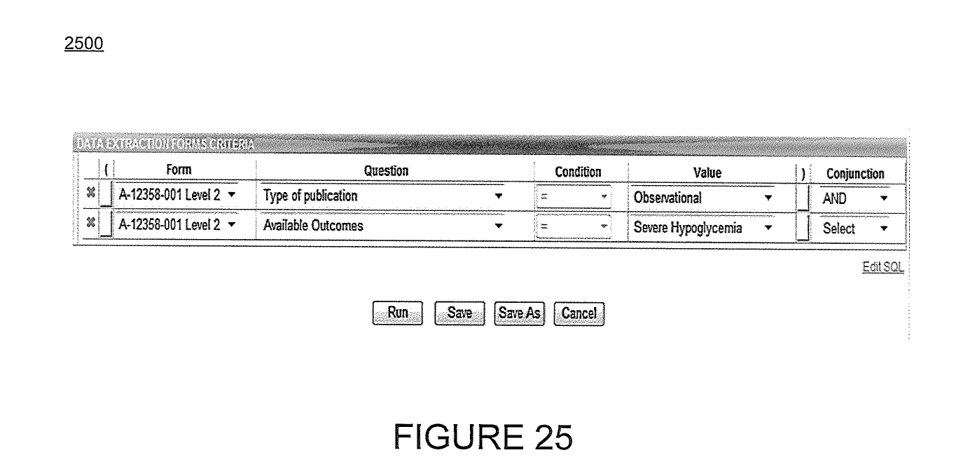

In some embodiments, various reports may be generated by the reporting module 420 relating to the literature review project, the literature review items 112 within the literature review project, and the like. Referring to FIG. 25, a query report display 2500 generated by the reporting module 420 reflects that a device operator may request the generation of various reports, e.g., by selecting different options from within the query report display 2500. Examples of reports that may be generated using the query report display 2500 may include, but are not limited to, reports on how many literature review items 112 have been entered into the system (e.g., to be included in the literature review project), how many literature review items 112 have been accepted into the study, and/or accepted into the study at specified levels, how many literature review items 112 have been rejected from the study, and the like.

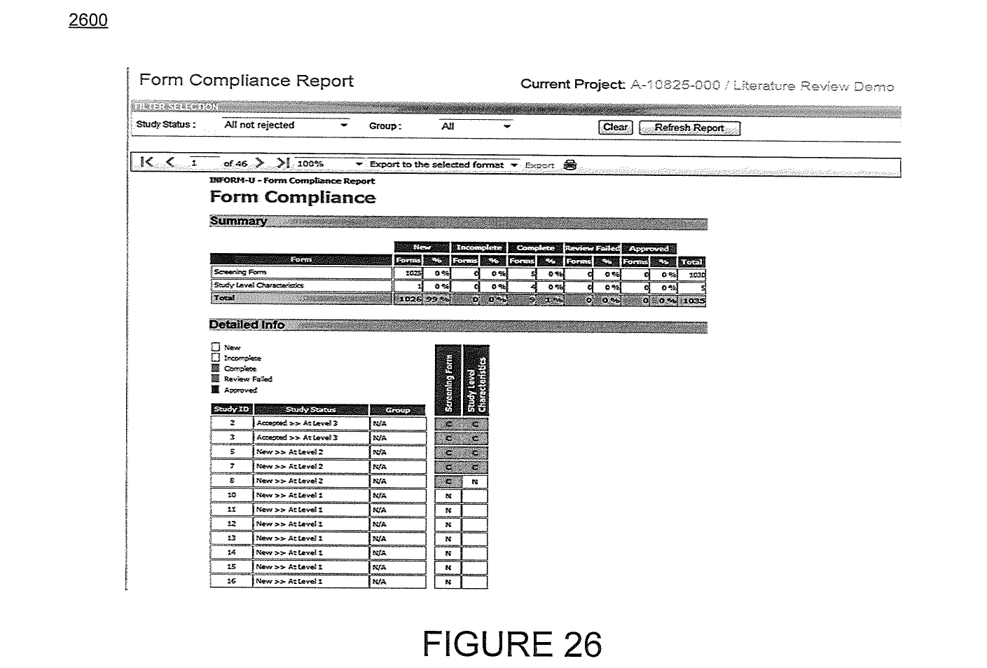

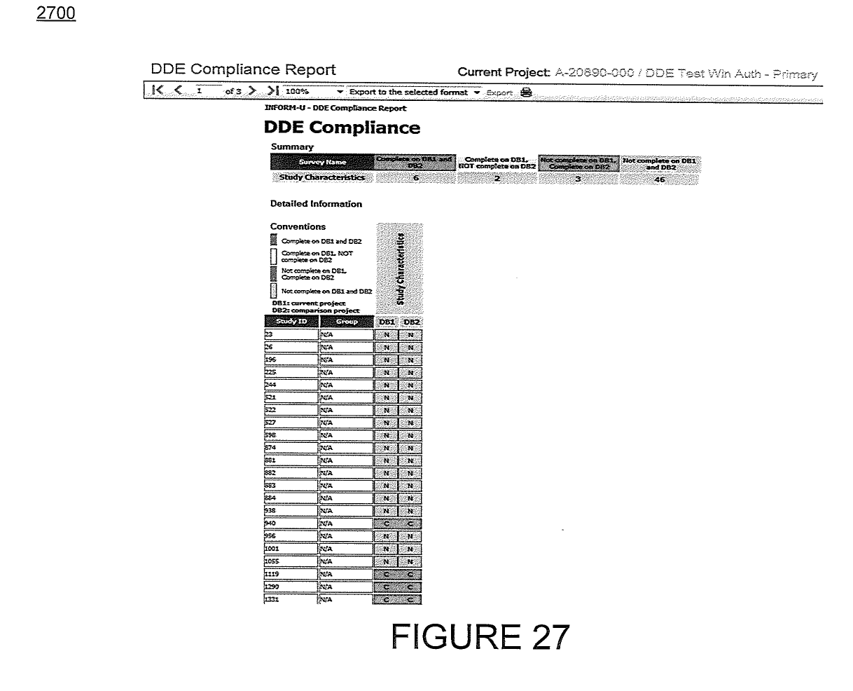

FIGS. 26 and 27 include displays 2600, 2700 that reflect example reports that may be generated by the reporting module 420, for example, based upon, at least in part, criteria selected by the device operator using the query report display 2500. For example, FIG. 26 shows a display 2600 including an example report indicating the status of the data entry forms, how many data entry forms are included within the literature review project, how many of the data entry forms are incomplete, how many of the data entry forms are complete, and the like. Another example report, regarding double data entry compliance is shown in an example display 2700 in FIG. 27. The example double data entry compliance report may indicate, for example, the status of the double data entry, the number of data entry forms that have been entered, the number of data entry forms that remain incomplete and the like. Various additional and/or alternative reports may be generated regarding different attributes of the literature review project.

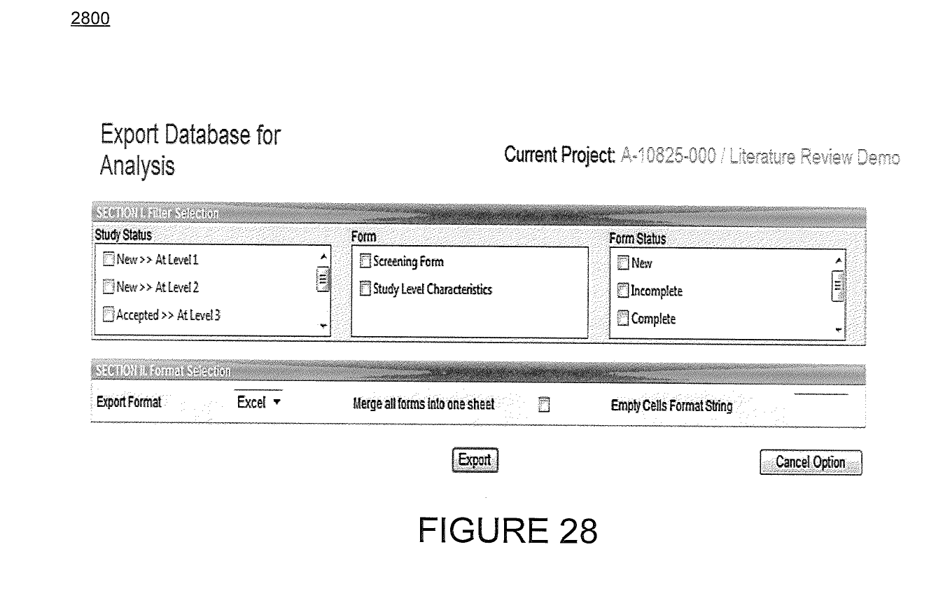

In some situations it may be desirable to provide additional statistical analysis on various data regarding a literature review project. In an example embodiment, data regarding the literature review project may be exported by the export module 418, e.g., as for use by another program or application. For example, and referring to FIG. 28, an export display 2800 generated by the export module 418 reflects that the device operator may export data regarding a literature review project, and/or data collected within the forms of a literature review project, for use by another program, such as MICROSOFT EXCEL, MICROSOFT ACCESS, and/or another suitable programs. Examples of information that may be exported may include, but is not limited to, information collected by the various data entry forms, literature review item information (such as publication year, author, the abstract of the literature review items, whether the literature review item was accepted or rejected, or the like). The export display 2800 may allow the device operator to select the information to be exported and a format for the exported data (e.g., by identifying a program or application by which the exported data may be used), as well as various other filtering options for the data to be exported.

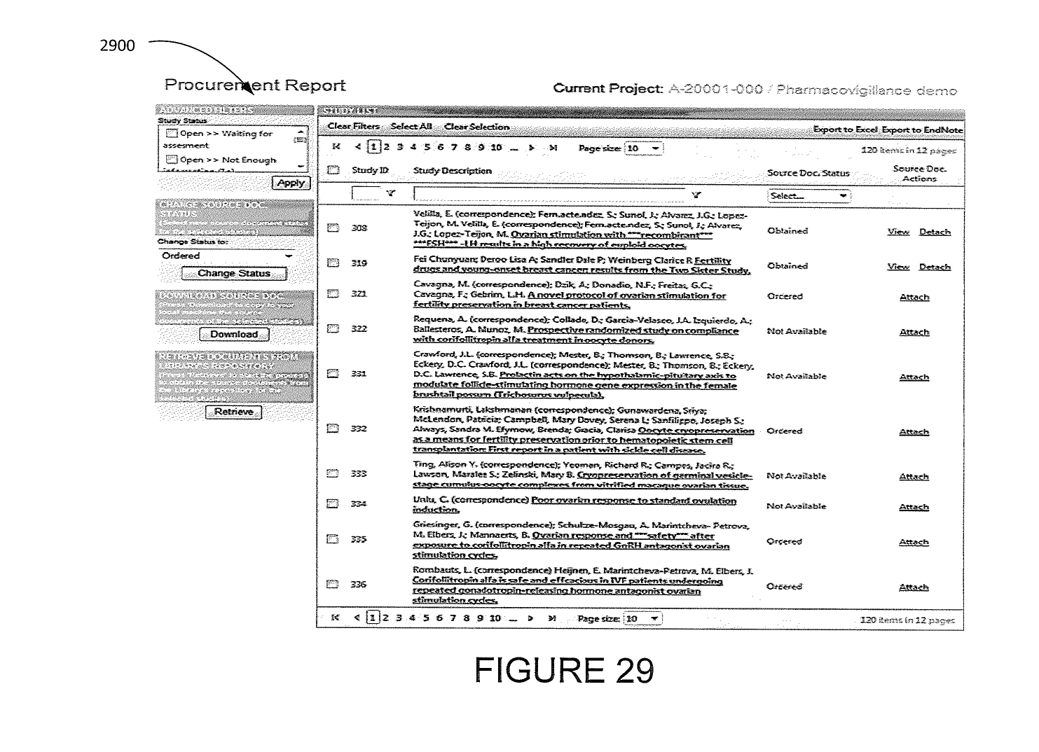

FIG. 29 shows a display 2900 generated by the reporting module 420 that reflects a procurement report. The display 2900 depicts that a device operator may manage the process of obtaining the full text files or source documents of selected literature review items 112. The device operator may attempt to retrieve the source document from a central repository or library internally held such as the literature review items 112 contained within the database 108. If the retrieval attempt is not successful, options for ordering the selected literature review items 112 may be provided from an external source (e.g., client, third party, or the like) and to track the progress of the source document retrieval until they are obtained or they are identified as not available.

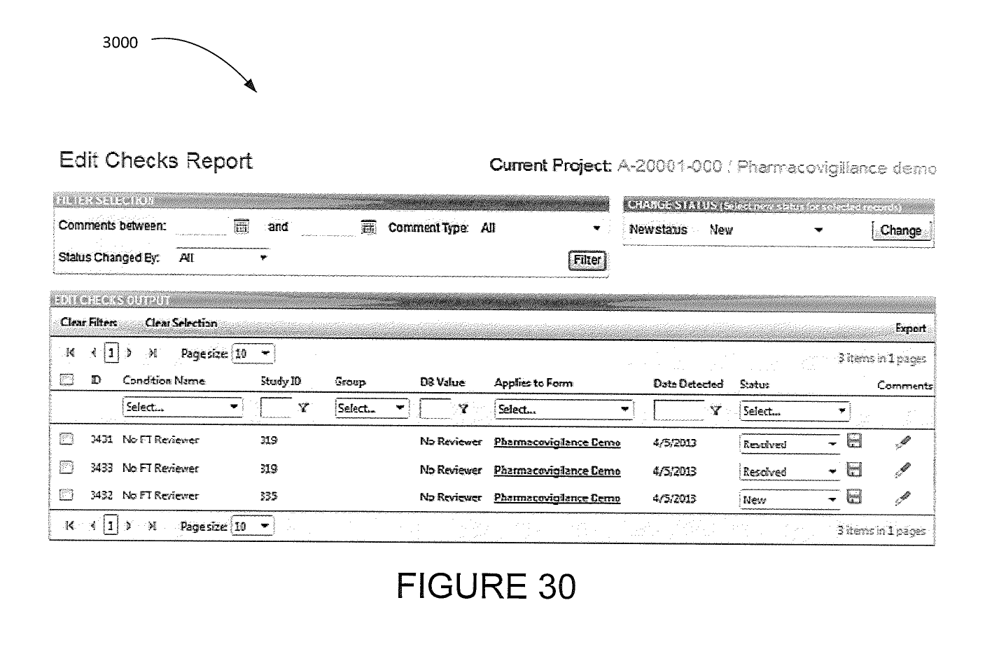

FIG. 30 shows a display 3000 generated by the reporting module 420 that reflects an edits checks report. The display 3000 depicts that a device operator may implement and manage automatic edit checks on the data captured during a literature project. The edit checks may evaluate unusual but permitted conditions on either single or multiple data fields and/or through different forms. When those conditions are detected, an entry is shown in the report which allows a device operator to investigate the accuracy of the data until it is resolved or discarded. During this process, tracking entries are captured for every action or change of status.

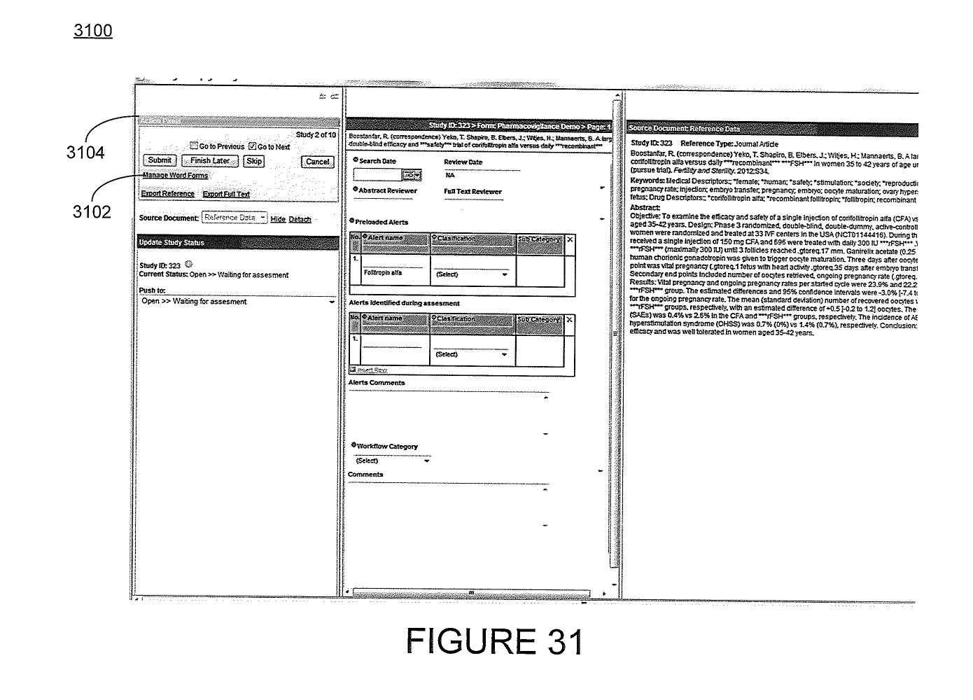

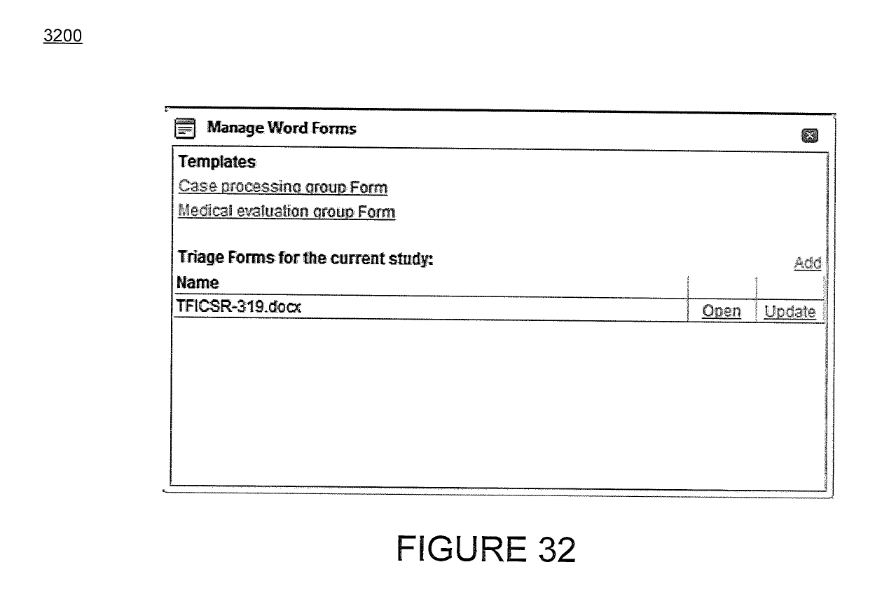

FIGS. 31 and 32 shows displays 3100, 3200 generated by the document analysis and processing subsystem 202 that reflect in some situations safety information included within the literature review items 112 being reviewed that may be reported for additional processing. For example, a search may be reflected on the abstract and/or full text of a literature review item 112 relative to keywords related to safety (e.g., as of a pharmaceutical or the like). In the display 3100 shown in FIG. 31, in response to detecting some safety related information (e.g., based upon, at least in part, the keyword search), a Manage Word Forms option 3102 may be provided within the action panel 3104 included within the display 3100. In response to a device operator selecting the Managed Word Forms option 3102, the display 3200 shown in FIG. 32 may be provided. The display 3200 reflects that the literature review item 112 including the identified safety related information may be uploaded or transmitted for additional processing.

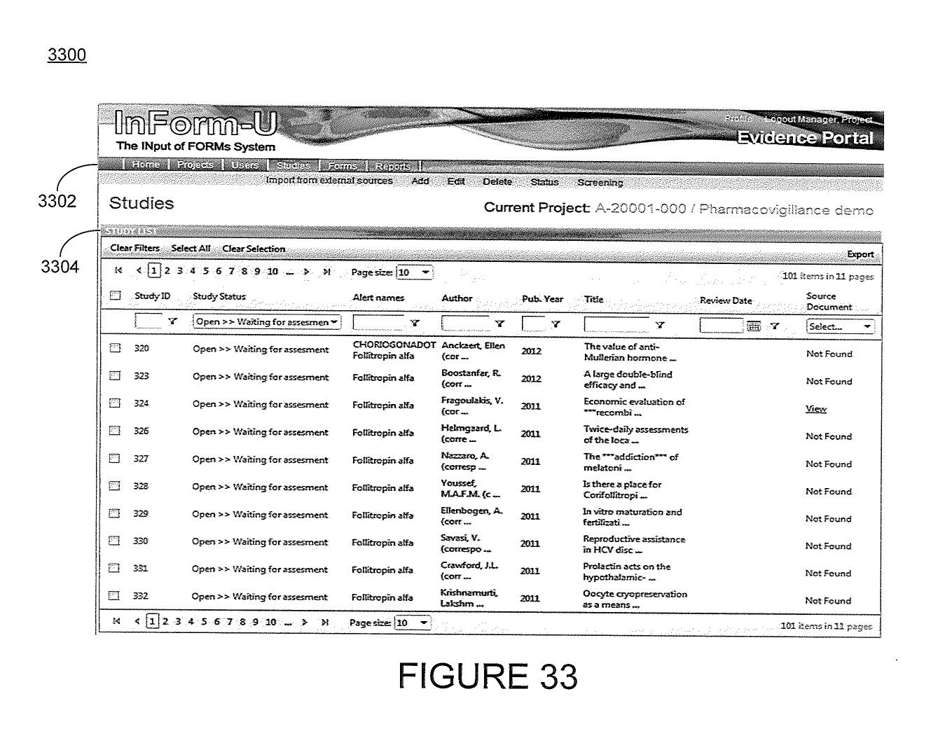

FIG. 33 shows a main access display 3300 generated by the document analysis and processing subsystem 202, which reflects an example of a primary or main access point into the document analysis and processing subsystem 202, once a device operator logs into the document analysis and processing subsystem 202. As shown, the main access display 3300 may include a menu bar 3302 including various options, which, when selected by a device operator, may allow the device operator to access various functionality or features provided by the system. For example, the “Home” option may provide a user with a first level access to the document analysis and processing subsystem 202. The “Projects” option may allow the device operator to view, access, and/or configure the various projects for which the device operator has access permissions. The “Users” option may allow the device operator to view the various users who are authorized to access projects, which projects the users are authorized to access, etc. The “Studies” option (e.g., which is shown as being the currently selected option) may display (e.g., in “Study List” pane 3304) a list of all of the literature review items 112 associated with a selected literature review project that have been imported for use by the document analysis and processing subsystem 202. The “Forms” option within the menu bar 3302 may allow the device operator to access the forms which may be used for abstracting data from the various literature review items 112 associated with a literature review project. The “Reports” option may allow the device operator to request the generation of reports through the reporting module 420 regarding literature review projects, literature review items 112, and the like.

In the depicted main access display 3300, the Studies option is the currently selected option. As such, additional options may be available. The additional options may include an option to “Import from external sources” which may allow the device operator to import literature review items into a working database associated with the selected project. Options may also be provided to add, edit, and delete literature review items 112, and to determine the review status of a literature review item 112 or a literature review project, and to review screening information of literature review items 112. Further, the Study List pane 3304, shown in the main access display 3300, may list the various literature review items 112 associated with a selected literature review process, which have been imported into the working database associated with the selected project. As shown, various attributes regarding the literature review items 112 may be displayed in the study list pane 3304. For example, columns may be included to indicate the review status of the literature review items 112, the author, publication year, and title of the literature review items 112, and alert name (e.g., which may identify a pharmaceutical or the like that may be a basis for the literature review project). Individual literature review items 112 may be selected from within the study list pane 3304, e.g., to review the literature review item 112, conduct data abstraction and data entry, or the like.

While the foregoing example has generally related to the field of literature review for pharmaceutical studies or medical treatment studies, it will be appreciated that the document analysis and processing subsystem 202 may be utilized in connection with other, non-pharmaceutical, or non-medical treatment related literature review projects.

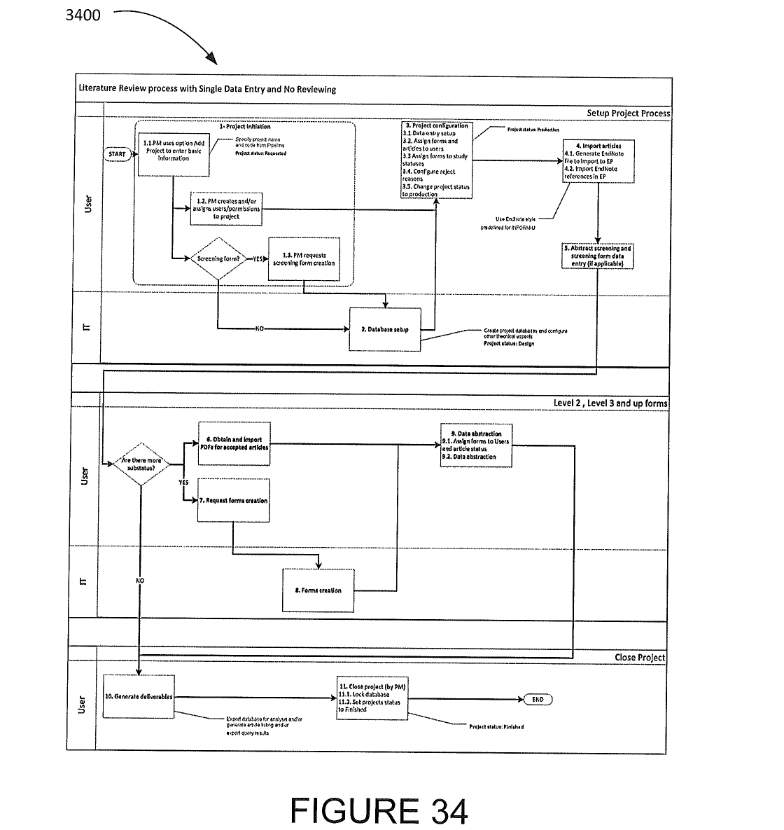

FIG. 34 is an example process flow illustrating a method 3400 for conducting a literature review process, according to an example embodiment. The method 3400 reflects a literature review process with single data entry and no reviewing. The method 3400 reflects that during project initiation, a project name and code (e.g., from a project pipeline) is specified. The project status may then been deemed to be requested. Such information may be provided by a user through the project definition module 404. Users and permissions may then be created and/or assigned to the literature review project. A screening data entry form may then be created or requested. Setup of the database 108 may then be performed at which the project status may be deemed to be in design.

The project may be configured by use of the project definition module 404 through which various operations may be performed including data entry setup, assignment of data entry forms and articles to users, configuration of rejection reasons, and modification of the project status to production.

Articles may then be imported. For example, ENDNOTE files and ENDNOTE references may be generated and imported. Screen and screening format data entry may then be abstracted.

A determination may then be made as to whether there are more sub-status. When there is, PDFs may be obtained and imported for accepted articles. A request for forms creation and the forms creation itself may be performed. Data abstraction and assigned forms to user and article status may also be performed. Deliverables may be generated including exporting a database for analysis, generation article listings, and/or exporting query results. The project may then be closed out, the database locked and the project status set to finished.

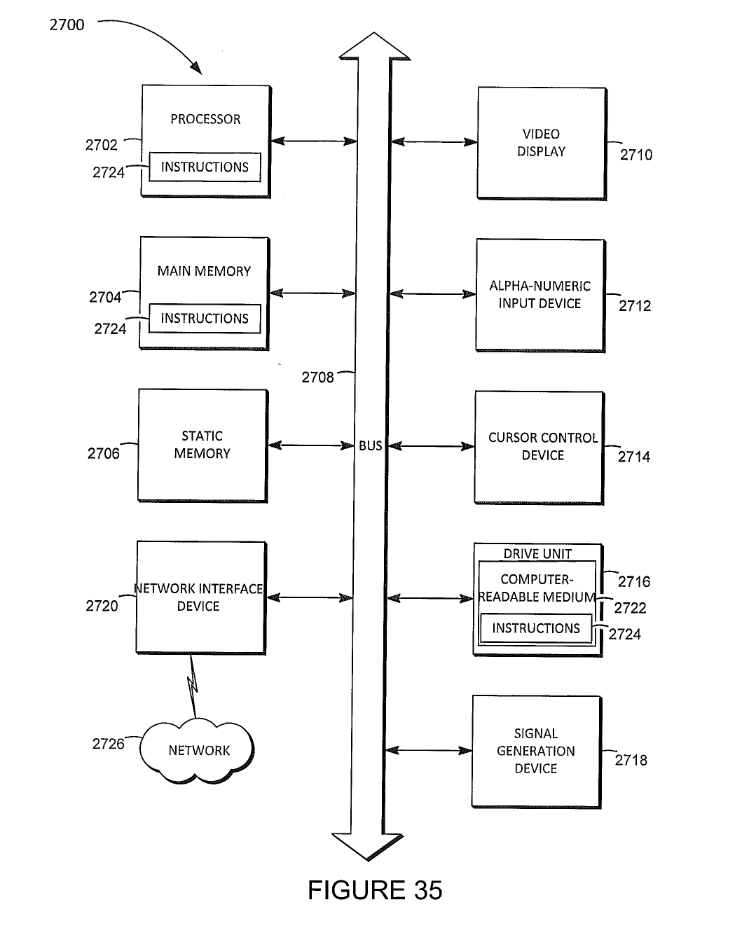

FIG. 35 shows a block diagram of a machine in the example form of a computer system 3500 within which a set of instructions may be executed causing the machine to perform any one or more of the methods, processes, operations, or methodologies discussed herein. Such a machine can be a dedicated machine for literature review projects when instructions for producing the displays or performing any method described herein are loaded into a processor. The operator device 102, the resource device 106 may include the functionality of the one or more computer systems 3500.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a gaming device, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3500 includes a processor 3512 (e.g., a central processing unit (CPU) a graphics processing unit (GPU) or both), a main memory 3504 and a static memory 3506, which communicate with each other via a bus 3508. The computer system 3500 further includes a video display unit 3510 (e.g., a liquid crystal display (LCD) or a cathode ray tube (CRT)). The computer system 3500 also includes an alphanumeric input device 3512 (e.g., a keyboard), a cursor control device 3514 (e.g., a mouse), a drive unit 3516, a signal generation device 3518 (e.g., a speaker) and a network interface device 3520.

The drive unit 3516 includes a computer-readable medium 3522 on which is stored one or more sets of instructions (e.g., software 3524) embodying any one or more of the methodologies or functions described herein. The software 3524 may also reside, completely or at least partially, within the main memory 3504 and/or within the processor 3512 during execution thereof by the computer system 3500, the main memory 3504 and the processor 3512 also constituting computer-readable media.

The software 3524 may further be transmitted or received over a network 3526 via the network interface device 3520.

While the computer-readable medium 3522 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform any one or more of the methodologies of the present invention. The term “computer-readable medium” shall accordingly be taken to include, but not be limited to, solid-state memories, and optical media, and magnetic media. In some embodiments, the computer-readable medium is a non-transitory computer-readable medium.

The term “based on” or using, as used herein, reflects an open-ended term that can reflect others elements beyond those explicitly recited.

Certain systems, apparatus, applications or processes are described herein as including a number of modules. A module may be a unit of distinct functionality that may be presented in software, hardware, or combinations thereof. When the functionality of a module is performed in any part through software, the module includes a computer-readable medium. The modules may be regarded as being communicatively coupled.

The inventive subject matter may be represented in a variety of different embodiments of which there are many possible permutations.

In an example embodiment, review criteria for a literature review project are stored. The review criteria includes criteria for literature review item inclusion, literature review item exclusion, or literature review item inclusion and exclusion in a study on a topic. A data entry definition of a plurality of data entry forms for the literature review project is stored. The plurality of data entry forms is configured in accordance with the data entry definition to receive literature review item analysis information through a multi-level review. A methodology definition of a data entry methodology is stored. The methodology definition defines a number of per item reviewers for the literature review project. Limited information access is provided to a plurality of literature review items identified in a literature review search on the topic. Initial review data is received through a first data entry form in accordance with the data entry methodology and providing of the limited information access to the plurality of literature review items. A first literature review item is automatically included from the study based on receipt of the initial review data associated with the first literature review item. A second literature review item is automatically excluded from the study based on receipt of the initial review data associated with the second literature review item. An exclusion indication associated with a third literature review item is received to manually exclude the third literature review item. A determination is made that a fourth literature review item of the plurality of literature review items has met an acceptance criterion based on receipt of the initial review data associated with the fourth literature review item. The fourth literature review item is moved through at least one additional level of review based on a determination that the fourth literature review item has met the acceptance criterion. Greater information access is provided to the fourth literature review item based on movement of the fourth literature review item. The greater information access includes greater detailed information not included with the limited information access. Additional review data is received through a second data entry form in accordance with the data entry methodology and providing of the greater information access to the fourth literature review item. Literature review report data of the plurality of literature review items is exported based on receipt of the initial review data, automatic inclusion of the first literature review item, automatic exclusion of the second literature review item, manual exclusion of the third literature review item, and receipt of the additional review data.

In an example embodiment, review criteria for a literature review project are stored. The review criteria includes criteria for literature review item inclusion, literature review item exclusion, or literature review item inclusion and exclusion in a study on a topic. A data entry definition of a plurality of data entry forms for the literature review project is stored. The plurality of data entry forms is configured in accordance with the data entry definition to receive literature review item analysis information through a multi-level review. A methodology definition of a data entry methodology is stored. The methodology definition reflects a double data entry methodology for the literature review project. Limited information access is provided to a first portion of a plurality of literature review items identified in a literature review search to a first person. Limited information access is provided to a second portion of the plurality of literature review items identified in the literature review search to a second person. Initial review data is received through the data entry form in accordance with the data entry methodology and providing of the limited information access to the first portion and the second portion of the plurality of literature review items. A determination that a literature review item of the plurality of literature review items has met an acceptance criterion based on receipt of the initial review data associated with the literature review item is made. The literature review item is moved through at least one additional level of review based on a determination that the literature review item has met the acceptance criterion. Greater information access is provided to the literature review item based on movement of the literature review item. Additional review data is received through the data entry form in accordance with the data entry methodology and providing of the greater information access to the literature review item. A discrepancy is identified among the initial review data, the additional review data, or the initial review data and the additional review data received from the first person and the second person. Correction data is received through an additional data entry form in response to identification of the discrepancy. Literature review report data of the plurality of literature review items is exported based on receipt of the initial review data, the additional review data, and the correction data.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein, “a” or “an” may reflect a single part or multiple parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The systems may be computing machines specifically configured to execute the instructions as described herein. The instructions may be rules in the form of computing code that can be executed by the computing machine or can be instructions loaded into the circuitry of the computing machines.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed is:

1. A method comprising:
storing a review criteria for a literature review project, the review criteria including criteria for literature review item inclusion, literature review item exclusion, or literature review item inclusion and exclusion in a study on a topic;
storing a data entry definition of a plurality of data entry forms for the literature review project, the plurality of data entry forms being configured in accordance with the data entry definition to receive literature review item analysis information through a multi-level review;
storing a methodology definition of a data entry methodology, the methodology definition defining a number of per item reviewers for the literature review project;
providing limited information access to a plurality of literature review items identified in a literature review search on the topic;
receiving initial review data through a first data entry form in accordance with the data entry methodology and providing of the limited information access to the plurality of literature review items;
automatically including a first literature review item from the study based on receipt of the initial review data associated with the first literature review item;
automatically excluding a second literature review item from the study based on receipt of the initial review data associated with the second literature review item;
receiving an exclusion indication associated with a third literature review item to manually exclude the third literature review item;
determining that a fourth literature review item of the plurality of literature review items has met an acceptance criterion based on receipt of the initial review data associated with the fourth literature review item;
moving the fourth literature review item through at least one additional level of review based on a determination that the fourth literature review item has met the acceptance criterion;
providing greater information access to the fourth literature review item based on movement of the fourth literature review item, the greater information access including greater detailed information not included with the limited information access;
receiving additional review data through a second data entry form in accordance with the data entry methodology and providing of the greater information access to the fourth literature review item; and
exporting literature review report data of the plurality of literature review items based on receipt of the initial review data, automatic inclusion of the first literature review item, automatic exclusion of the second literature review item, manual exclusion of the third literature review item, and receipt of the additional review data.

2. The method of claim 1, further comprising:
generating a literature review report of the plurality of literature review items based on the receipt of the initial review data, the automatic inclusion of the first literature review item, the automatic exclusion of the second literature review item, the manual exclusion of the third literature review item, and the receipt of the additional review data.

3. The method of claim 1, further comprising:
accessing keyword highlighting configuration data,
wherein providing greater information access to the fourth literature review item based on movement of the fourth literature review item includes generating a user interface including a portion of text of the fourth literature review item highlighted in accordance with the keyword highlighting configuration data.

4. The method of claim 1, further comprising:
conducting, across a plurality of literature sources, a literature review search on the topic to identify the plurality of literature review items;
storing a result of the literature review search.

5. The method of claim 1, wherein moving the fourth literature review item through at least one additional level of review comprises:
automatically moving the fourth literature review item through the at least one additional level of review based on the determination that the fourth literature review item has met the acceptance criterion.

6. The method of claim 1, further comprising:
receiving a literature review item movement indication,
wherein moving the fourth literature review item through at least one additional level of review based on a determination that the fourth literature review item has met the acceptance criterion and receipt of the literature review item movement indication.

7. The method of claim 1, wherein the review criteria include a manual exclusion criterion that defines a basis by which a data entry user can manually exclude a literature review item.

8. The method of claim 1, wherein the review criteria include an automatic exclusion criterion that defines a basis by which a literature review item is automatically excluded.

9. The method of claim 1, wherein a data entry form of the plurality of data entry forms includes identification of a plurality of pieces of information to be collected or abstracted from a literature review item of the plurality of literature review items.

10. The method of claim 1, wherein the methodology definition includes a double data entry methodology.

11. The method of claim 1, wherein the methodology definition includes a review and discrepancy methodology.

12. The method of claim 1, wherein the limited information access to the plurality of literature review items is abstract text of the plurality of literature review items.

13. The method of claim 1, wherein the exclusion indication includes an indicated reason for exclusion.

14. The method of claim 1, further comprising:
associating a data entry user with a literature review project.

15. A method comprising:
storing a review criteria for a literature review project, the review criteria including criteria for literature review item inclusion, literature review item exclusion, or literature review item inclusion and exclusion in a study on a topic;
storing a data entry definition of a plurality of data entry forms for the literature review project, the plurality of data entry forms being configured in accordance with the data entry definition to receive literature review item analysis information through a multi-level review;
storing a methodology definition of a data entry methodology, the methodology definition reflecting a double data entry methodology for the literature review project;
providing limited information access to a first portion of a plurality of literature review items identified in a literature review search to a first person;
providing limited information access to a second portion of the plurality of literature review items identified in the literature review search to a second person;
receiving initial review data through the data entry form in accordance with the data entry methodology and providing of the limited information access to the first portion and the second portion of the plurality of literature review items;
determining that a literature review item of the plurality of literature review items has met an acceptance criterion based on receipt of the initial review data associated with the literature review item;
moving the literature review item through at least one additional level of review based on a determination that the literature review item has met the acceptance criterion;
providing greater information access to the literature review item based on movement of the literature review item;
receiving additional review data through the data entry form in accordance with the data entry methodology and providing of the greater information access to the literature review item;
identifying a discrepancy among the initial review data, the additional review data, or the initial review data and the additional review data received from the first person and the second person;
receiving correction data through an additional data entry form in response to identification of the discrepancy; and
exporting literature review report data of the plurality of literature review items based on receipt of the initial review data, the additional review data, and the correction data.

16. The method of claim 15, wherein the initial review data includes an acceptance of the literature review item.

17. The method of claim 15, wherein the additional review data includes a rejection of the literature review item and a reject reason for the rejection of the literature review item.

18. The method of claim 17, wherein the discrepancy is the rejection reason for the rejection of the literature review item received from the first person and the second person.

19. The method of claim 18, wherein the discrepancy is an acceptance of the literature review item at a first level of review by a first person and a rejection of the literature review item at a second level of review by a second person.
